(19) United States
(12) Patent Application Publication
(10) Pub. No.: US 2012/0002257 A1
(43) Pub. Date: Jan. 5, 2012

(54) HOLOGRAM RECORDING MEDIUM AND METHOD FOR MANUFACTURING THE SAME, HOLOGRAM REPRODUCTION APPARATUS, AND HOLOGRAM REPRODUCTION METHOD

(75) Inventors: Akira Shirakura, Tokyo (JP); Teruaki Higashihara, Tokyo (JP); Toshiyuki Arai, Kanagawa (JP); Shigeyuki Baba, Tokyo (JP)

(73) Assignees: SONY DADC CORPORATION, Tokyo (JP); SONY CORPORATION, Tokyo (JP)

(21) Appl. No.: 13/153,968

(22) Filed: Jun. 6, 2011

(30) Foreign Application Priority Data
Jun. 30, 2010 (JP) 2010-149572

(51) Int. Cl. G03H 1/26; G03H 1/24; G03H 1/22

(52) U.S. Cl. 359/22; 359/32

(57) ABSTRACT

A hologram recording medium having two or more images recorded therein, wherein when substantially collimated light is incident along a first direction on the hologram recording medium, a first image is reproduced with the intensity of light diffracted in the hologram recording medium maximized in a predetermined direction, when substantially collimated light is incident along a second direction on the hologram recording medium, a second image is reproduced with the intensity of light diffracted in the hologram recording medium maximized in the predetermined direction, and a full width at half maximum of a reproduction angle of at least either of the diffracted light intensities of the first and second images is 8° or smaller.

### FIELD

The present disclosure relates to a hologram recording medium and a method for manufacturing the same, a hologram reproduction apparatus, and a hologram reproduction method, and particularly to a hologram recording medium in which multiple pieces of information, such as characters, barcodes, and other image information expressed in a planar shape, are recorded and a method for manufacturing the hologram recording medium. The present disclosure also relates to a hologram reproduction apparatus that reproduces information recorded in the hologram recording medium and converts the reproduced information in an opto-electric conversion process, and a hologram reproduction method.

### BACKGROUND

A hologram, which enables stereoscopic display, is used to authenticate a credit card, an ID card or other identification cards. Among many types of hologram, a volume hologram, in which an interference pattern is recorded in the form of difference in refractive index in a recording layer, is often used in recent years. The reason for this is that it is difficult to counterfeit a volume hologram without using a sophisticated technology for recording an image and that a recording material used in a volume hologram is hardly available.

On the other hand, a technology for replicating a volume hologram has been advancing from day to day, and it is desirable to provide a hologram with a more sophisticated authentication function and counterfeit-resistant features. Further, there is a demand for simple authentication, for example, by machine-reading information recorded in a hologram.

A screen-switching hologram that allows a reproduced image to be switched in accordance with the direction in which the hologram is viewed is disclosed as a method for providing a volume hologram with a more sophisticated authentication function (see JP-A-2008-122670, for example).

In the screen-switching hologram described above, however, multiple pieces of recorded image information are recognized visually, which is inconvenient. Further, since a single master plate is used to produce a large number of holograms, it is difficult to provide the holograms themselves with a more sophisticated authentication function that allows, for example, the holograms to be individually identified.

### SUMMARY

It is desirable to provide a hologram recording medium capable of providing counterfeit resistance and convenience and a method for manufacturing the hologram recording medium, a hologram reproduction apparatus, and a hologram reproduction method.

The present inventors have conducted intensive studies to solve the problems described above with related art and attained a hologram recording medium in which an image replicated from a hologram master plate and identification information on an individual hologram itself (hereinafter referred as appropriate to as individual ID information) are recorded.

As described above, there has been a demand to machine-read information recorded in a hologram. For example, there has been a demand to reproduce character information, barcode information, and other information recorded holographically as individual ID information, convert the reproduced optical information into an electric information by using an imaging camera or any other suitable device, and machine-read the electric information.

To reproduce information recorded in a hologram, it is necessary to illuminate the hologram with light, such as collimated light traveling in a single direction or light from a point light source. When the hologram is illuminated with light beams from a plurality of different directions, a plurality of images are reproduced and disadvantageously superimposed to form multiple images. That is, the reproduced hologram images disadvantageously form a blurred image.

When the information reproduced from the hologram form multiple images, it is difficult to machine-read the images accurately.

To address the problem, the inventors have intensively conducted studies on a hologram recording medium that reproduces holographically recorded character information, barcode information, and other information without producing multiple images. As a result, the inventors have attained a hologram recording medium that allows multiple pieces of information to be recorded and any of the multiple pieces of image information expressed in a planar form to be selectively reproduced within a certain angular range only when the hologram is illuminated with light from a predetermined direction.

A preferred embodiment of a hologram recording medium is configured as follows.

Two or more images are recorded in the hologram recording medium;

when substantially collimated light is incident along a first direction on the hologram recording medium, a first image is reproduced with the intensity of light diffracted in the hologram recording medium maximized in a predetermined direction;

when substantially collimated light is incident along a second direction on the hologram recording medium, a second image is reproduced with the intensity of light diffracted in the hologram recording medium maximized in the predetermined direction; and

a full width at half maximum of a reproduction angle of at least either of the diffracted light intensities of the first and second images is 8° or smaller.

A preferred embodiment of a method for manufacturing a hologram recording medium is configured as follows.

The method includes modulating laser beams in spatial light modulators into laser beams each of which contains additional information and irradiating a hologram recording medium through focusing optical systems with the modulated laser beams along with reference light; and

at least one of the focusing optical systems provides a diffusion angle having an absolute value of 7° or smaller.

A preferred embodiment of a hologram reproduction apparatus is configured as follows.

The apparatus includes:

a viewing stage having an opening,

a support member fixed to at least part of the viewing stage,

a light blocking member having a light blocking portion and mounted on the support member on a side closer to a viewer than the viewing stage, and

a plurality of light sources mounted on the support member;

the viewing stage is configured to position a hologram to be viewed when placed in the opening;

each of the plurality of light sources illuminates the hologram in a predetermined direction;

a portion of the light blocking member that corresponds to a portion above at least the opening is an optical opening; and

the light blocking portion prevents illumination light from each of the light sources from directly exiting through the optical opening.

A preferred embodiment of a hologram viewing method is configured as follows.

The method includes:

(defining a direction of a normal dropped to a hologram having multiple pieces of image information recorded therein, a direction of illumination light that illuminates the hologram, and a direction in which the hologram is viewed),

selecting image information from the multiple pieces of image information recorded in the hologram by fixing any two of the directions and changing the remaining direction, and

viewing the selected image information.

According to the preferred embodiment of a hologram recording medium, a full width at half maximum of the diffracted light intensity of an image reproduced from the hologram recording medium is defined. That is, information recorded in the hologram recording medium has been recorded by object light having a defined diffusion angle. Information is therefore recorded in a planar shape in the hologram recording medium, and when the hologram recording medium is illuminated with light from a predetermined direction, a sharp image is reproduced.

According to the preferred embodiment of hologram reproduction apparatus, a hologram can be placed and positioned in the opening in the viewing stage. The hologram can therefore be reliably illuminated with light from a predetermined direction, and information recorded in the hologram can be reliably recognized by a viewer even when a full width at half maximum of the diffracted light intensity of an image reproduced from the hologram is defined.

The diffracted light intensity used herein refers to a value measured by using the following method. FIGS. 26A and 26B are schematic views showing a method for measuring the diffracted light intensity. A hologram 101 to be measured is placed on a black sheet 102, as shown in FIG. 26A. A measuring apparatus 701 is positioned above the hologram 101 in the direction of a normal thereto by a distance of 380 mm therefrom. An illumination light source 202 is fixed in a position set apart by 280 mm in the direction inclined to the normal to the hologram 101 by 45°.

The measuring apparatus and other components used in the measurement are as follows.

Measuring apparatus: Luminance and color meter (Konica-Minolta CS-200)

Illumination light source: Halogen light source (Y: 96.0, x: 0.4508, y: 0.4075 on XY chromaticity diagram)

Standard white plate: (Konica-Minolta CSA20)

The illumination light source 202 illuminates the hologram 101, and the measuring apparatus 701 measures reproduced light (diffracted light) from the hologram 101. In the measurement, the field of view is set at 0.2°, and (x, y) chromaticity coordinates and luminance LU1 are determined. The hologram is then replaced with the standard white plate, which is a reference, and the same measurement is performed on the standard white plate to determine the (x, y) chromaticity coordinates and illuminance LU2 with the field of view set at 0.2°. Let the intensity I of light diffracted in the hologram 101 be the ratio of the resultant LU1 to LU2. The reason why the hologram 101 is placed on the black sheet 102 is that it is necessary to eliminate any measurement error caused by the background otherwise visible through the hologram 101 when the reproduced light from the hologram 101 is measured.

The full width at half maximum (FWHM) of the reproduction angle of the diffracted light intensity used herein is the full width of the reproduction angle at half maximum of the diffracted light intensity and refers to, when the diffracted light intensity is expressed by a function of an angle β between a normal dropped to the hologram and a line connecting the foot of the normal dropped to the hologram to the measuring apparatus, an angular range obtained by doubling the angle at which the diffracted light intensity is one-half a maximum value thereof. FIG. 26B shows a graph representing the diffracted light intensity as a function of the angle β and the full width at half maximum associated with the graph. The diffracted light intensities I at angles ±γ are one-half the maximum, as shown in FIG. 26B. The full width at half maximum is therefore 2γ. The full width at half maximum of the diffracted light intensity shall hereinafter be referred to as the full width of the reproduction angle at half maximum of the diffracted light intensity.

The diffusion angle used herein is defined when a collimated laser beam having peak intensity within a visible wavelength range is incident on a diffusion object and refers to an angle at which the luminance of diffused light is one-half the central luminance thereof. A diffusion range can be determined by the following relationship.

(diffusion range)=2×(distance to irradiated surface)×(tangent of diffusion angle)

The angle used herein is not a solid angle but is a plane angle unless otherwise specified. For example, the angle of incidence of illumination light incident on a hologram refers to an angle defined in a plane containing a normal dropped to the hologram and a line connecting the foot of the normal dropped to the hologram to the light source and measured with respect to the normal.

According to at least one of the embodiments described above, a hologram recording medium having character information, barcode information, and other information holographically recorded therein can reproduce the information without producing multiple images.

### BRIEF DESCRIPTION OF THE DRAWINGS

FIG. 1 is a schematic diagram showing an exemplary configuration of an apparatus for manufacturing a hologram recording medium;

FIGS. 2A and 2B describe diffracted light intensity of an image reproduced from a hologram recording medium;

FIGS. 3A and 3B describe diffracted light intensity of an image reproduced from a hologram recording medium;

FIGS. 4A and 4B describe diffracted light intensity of an image reproduced from a hologram recording medium;

FIG. 5 is a schematic diagram for describing a viewing angle over which a reproduced image is viewed;

FIGS. 6A to 6F are schematic views showing reproduced images with the direction in which a hologram recording medium is viewed and the orientation of the hologram recording medium fixed and the direction in which illumination light is incident changed;

FIGS. 7A to 7F are schematic views showing reproduced images with the direction in which illumination light is incident and the orientation of a hologram recording medium fixed and the direction in which the hologram recording medium is viewed changed;

FIGS. 8A to 8F are schematic views showing reproduced images with the direction in which illumination light is incident and the direction in which a hologram recording medium is viewed fixed and the orientation of the hologram recording medium changed;

FIG. 9 is a schematic diagram showing a second exemplary configuration of the apparatus for manufacturing a hologram recording medium;

FIGS. 10A and 10B show an exemplary configuration of the hologram recording medium;

FIG. 11 shows another exemplary configuration of the apparatus for manufacturing a hologram recording medium;

FIGS. 12A and 12B show an exemplary configuration of an apparatus for reproducing a hologram recording medium;

FIGS. 13A and 13B also show the exemplary configuration of the apparatus for reproducing a hologram recording medium;

FIG. 14A is a diagrammatic view showing how an image is reproduced when a single LED light source illuminates a hologram recording medium, FIG. 14B is a diagrammatic view showing a reproduced image viewed when character information recorded in the hologram recording medium is reproduced by illuminating the hologram recording medium at a predetermined angle, and FIG. 14C is a diagrammatic view showing a reproduced image viewed when a two-dimensional barcode recorded in the hologram recording medium is reproduced by illuminating the hologram recording medium at another predetermined angle;

FIG. 15A describes an example of a light source for illuminating a hologram recording medium, FIG. 15B is a diagrammatic view showing a reproduced image viewed when character information recorded in the hologram recording medium is reproduced by illuminating the hologram recording medium at a predetermined angle, and FIG. 15C is a diagrammatic view showing a reproduced image viewed when a two-dimensional barcode recorded in the hologram recording medium is reproduced by illuminating the hologram recording medium at another predetermined angle;

FIG. 16A describes an example of a light source for illuminating a hologram recording medium, FIG. 16B is a diagrammatic view showing a reproduced image viewed when character information recorded in the hologram recording medium is reproduced by illuminating the hologram recording medium at a predetermined angle, and FIG. 16C is a diagrammatic view showing a reproduced image viewed when a two-dimensional barcode recorded in the hologram recording medium is reproduced by illuminating the hologram recording medium at another predetermined angle;

FIG. 17A describes an example of a light source for illuminating a hologram recording medium, FIG. 17B is a diagrammatic view showing a reproduced image viewed when character information recorded in the hologram recording medium is reproduced by illuminating the hologram recording medium at a predetermined angle, and FIG. 17C is a diagrammatic view showing a reproduced image viewed when a two-dimensional barcode recorded in the hologram recording medium is reproduced by illuminating the hologram recording medium at another predetermined angle;

FIG. 18A describes an example of a light source for illuminating a hologram recording medium, FIG. 18B is a diagrammatic view showing a reproduced image viewed when character information recorded in the hologram recording medium is reproduced by illuminating the hologram recording medium at a predetermined angle, and FIG. 18C is a diagrammatic view showing a reproduced image viewed when a two-dimensional barcode recorded in the hologram recording medium is reproduced by illuminating the hologram recording medium at another predetermined angle;

FIGS. 19A and 19B are schematic views showing an example in which a hologram recording medium having multiple pieces of 2D information recorded therein is attached to a product package;

FIGS. 20A and 20B are schematic views showing an example of reading an individual ID information formed of a barcode recorded in a hologram recording medium;

FIGS. 21A and 21B are schematic views showing an example in which a digital camera captures an image of a hologram recording medium having multiple pieces of 2D information recorded therein;

FIGS. 22A to 22D describe exemplary high-frequency patterns;

FIG. 23 is a diagrammatic cross-sectional view of an edge-lit backlight;

FIGS. 24A and 24B show a second exemplary configuration of the apparatus for reproducing a hologram recording medium;

FIGS. 25A and 25B also show the second exemplary configuration of the apparatus for reproducing a hologram recording medium;

FIG. 26A is a schematic view showing a method for measuring diffracted light intensity, and FIG. 26B shows a graph representing the diffracted light intensity as a function of an angle β and the full width at half maximum associated with the graph;

FIGS. 27A and 27B are schematic diagrams for describing an optical system used when information is recorded in a hologram recording medium and the information recorded in the hologram recording medium is reproduced;

FIG. 28 is a cross-sectional view showing an example of a hologram recording medium;

FIGS. 29A to 29C are schematic diagrams showing a process of exposing a photo-polymerization material to light; and

FIG. 30 is a schematic diagram schematically showing a contact copying apparatus.

### DETAILED DESCRIPTION

Embodiments of a hologram recording medium and a method for manufacturing the same, a hologram reproduction apparatus, and a hologram reproduction method will be described below. The description will be made in the following order.

<0. Volume hologram>

[Principle of recording and reproduction]

[Example of hologram recording medium]

[Replication based on contact printing]

### <1. First Embodiment>

[Exemplary configuration of manufacturing apparatus]
(Reference light optical system)
(Object light focusing optical system)
(Reference light)
(Object light)

[Hologram recording medium having 2D information recorded therein]
(Reproduction of recorded information)
(Control of viewing angle)
(Localization of 2D information)
(Switching reproduced image)

[Second exemplary configuration of first embodiment]

[Third example of configuration of first embodiment]

<2. Second embodiment>

[Exemplary configuration of manufacturing apparatus]

[Second exemplary configuration of second embodiment]

<3. Third embodiment>

[Exemplary configuration of hologram reproduction apparatus]
(Viewing hologram having 2D information recorded therein)
(Illumination light source)
(Acquisition of holographic 2D information by using imaging apparatus)
(High-frequency pattern)

[Second exemplary configuration of third embodiment]

### <4. Variations>

The following embodiments are preferred specific examples. In the following description, in which a variety of technically preferred limitations are imposed, examples of a hologram recording medium and a method for manufacturing the same, a hologram reproduction apparatus, and a hologram reproduction method are not limited to the following embodiments unless otherwise particularly stated that the present disclosure is limited to the embodiments.

### 0. Volume Hologram

A volume hologram will be summarized before the description of the embodiments for ease of understanding thereof.

### [Principle of Recording and Reproduction]

In a volume hologram, an interference pattern is recorded in the form of difference in refractive index in a recording layer, as described above. An interference pattern is recorded by irradiating a hologram recording medium with reference light and object light that contains information on an image to be recorded simultaneously but from different directions.

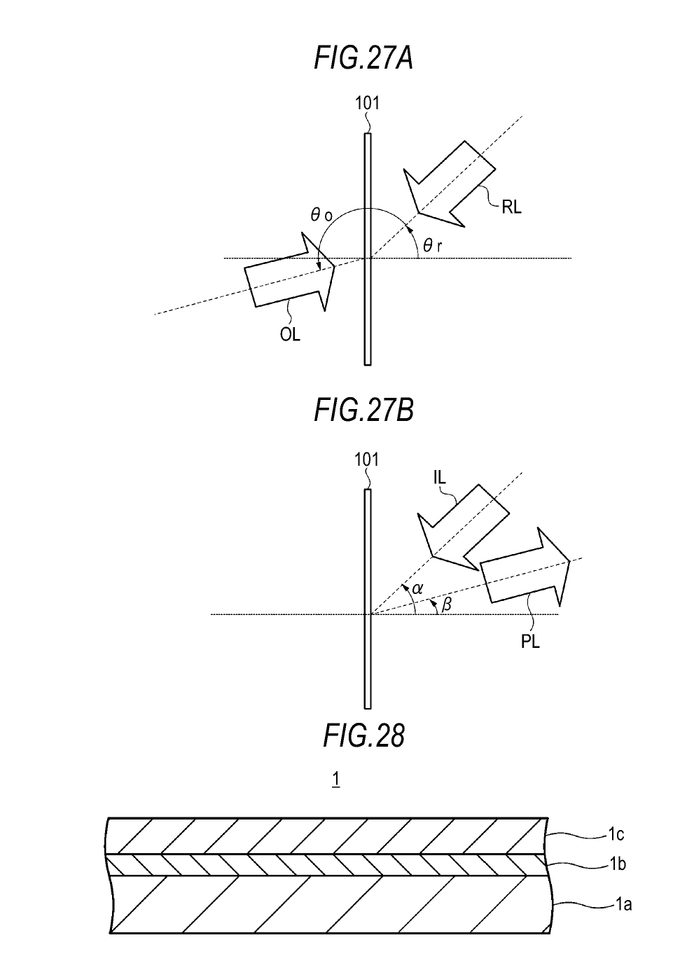

A description will be made of an optical system used when information is recorded in a hologram recording medium 101 and when the information recorded in the hologram recording medium 101 is reproduced with reference to FIGS. 27A and 27B.

At the time of recording, reference light RL is incident on the hologram recording medium 101 at an angle of incidence θr, and object light OL is incident on the opposite side of the hologram recording medium 101 at an angle of incidence θo, as shown in FIG. 27A. An interference pattern formed by the reference light RL and the object light OL is recorded in the hologram recording medium 101.

When the hologram recording medium 101 in which the interference pattern has been recorded is irradiated with illumination light IL at an angle of incidence α (α=θr) as shown in FIG. 27B, the illumination light IL is diffracted in the hologram recording medium 101, and reproduced light PL exits from the hologram recording medium 101 at an angle of emergence β (β=180°−θo). A viewer in the direction of the object light OL can therefore view a reproduced image.

When the recording shown in FIG. 27A is performed, the angle of incidence θr of the reference light is adjusted to adjust a preferable angle of illumination at which the hologram recording medium is illuminated, that is, the angle α. Further, the angle of incidence θo of the object light is adjusted to adjust a central angle at which the luminance of the reproduced light is maximized, that is, the angle β.

### [Example of Hologram Recording Medium]

An example of a hologram recording medium 1 used to record image information will now be described. The hologram recording medium 1 includes a film base la having a tape-like shape, a photo-polymer layer 1b made of a photo-polymerization material and formed on the film base 1a, and a cover sheet 1c coated on the photo-polymer layer 1b, as shown in FIG. 28. The hologram recording medium 1 is what is called a recording medium based on film application.

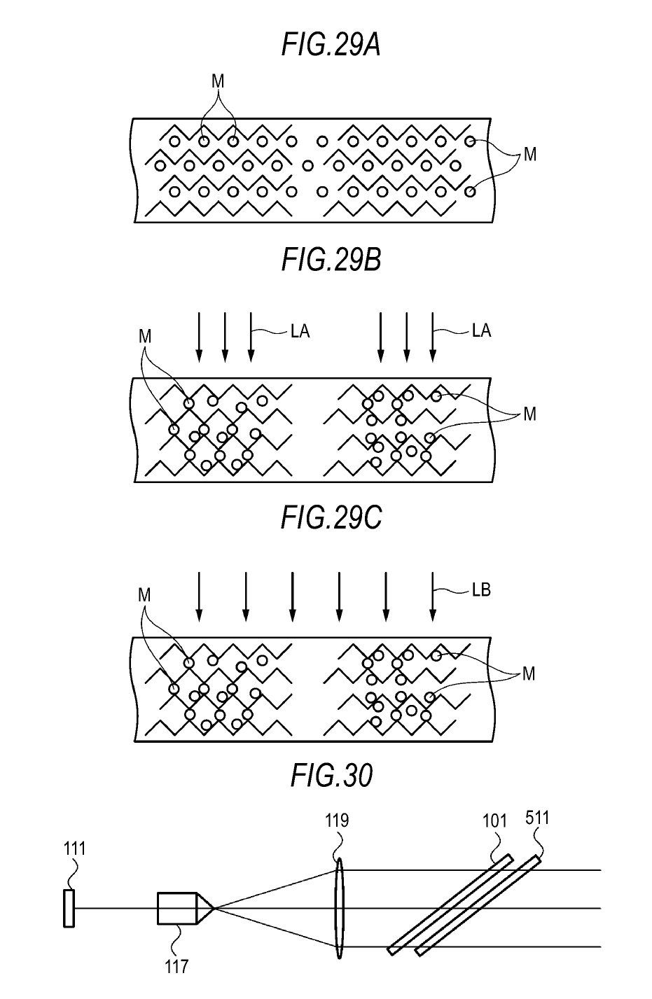

The photo-polymerization material is formed of a monomer M uniformly dispersed in a matrix polymer in an initial state, as shown in FIG. 29A. When the photo-polymerization material is irradiated with light LA having a power ranging from approximately 10 to 400 mJ/cm², the monomer M is polymerized in the portion exposed to the light, as shown in FIG. 29B. The monomer M around the polymerized portion then moves therein as the polymerization proceeds, and the concentration of the monomer M varies in the material. The refractive index is thus modulated in the material. The entire material is then irradiated with ultraviolet or visible light LB having a power of approximately 1000 mJ/cm², as shown in FIG. 29C, and the polymerization of the monomer M is completed. As described above, the refractive index of a photo-polymerization material changes in accordance with light incident thereon, whereby an interference pattern produced when the reference light interferes with the object light can be recorded in the form of change in the refractive index.

To fix the recorded image in the hologram recording medium 1 by increasing the degree of refractive index modulation in the photo-polymer layer 1b, a step of heating the hologram recording medium 1 may be added.

The hologram recording medium 1 made of the photo-polymerization material described above typically requires no special development process after the light exposure. Using the hologram recording medium 1 including a photosensitive portion made of the photo-polymerization material therefore allows the configuration of a hologram manufacturing apparatus and a hologram replicating apparatus to be simplified.

### [Replication Based on Contact Printing]

A volume hologram having image information recorded therein can be produced, as described above. Further, the image information recorded in the volume hologram can be reproduced, and the reproduced light is used as object light to copy the image information to another hologram recording medium. The method is called contact printing because a hologram having image information recorded therein is used as a master plate and the image information is recorded with another hologram recording medium being in intimate contact with the master plate. The replication based on the contact printing is hereinafter referred as appropriate to as contact copying.

FIG. 30 is a schematic diagram schematically showing a contact copying apparatus. In the contact copying apparatus, a laser beam from a laser light source 111 is enlarged by a spatial filter 117, and the enlarged light is incident on a collimation lens 119, as shown in FIG. 30. A hologram recording medium 101 containing a photosensitive material and a hologram master plate 511 are irradiated with the (S-polarized) laser beam collimated by the collimation lens 119.

The hologram master plate 511 is, for example, a Lippmann hologram. The hologram recording medium 101 including a photosensitive material layer and the hologram master plate 511 are so disposed that they come into intimate contact with each other directly or via a liquid that adjusts the refractive indices thereof (referred to as an index matching liquid). An interference pattern formed when light diffracted in the hologram master plate 511 interferes with the incident laser light is recorded in the hologram recording medium 101.

### 1. First Embodiment

An embodiment will next be described.

According to a first embodiment, multiple pieces of image information are recorded in a hologram recording medium. Each of the multiple pieces of image information is directly focused on a surface of the hologram recording medium and recorded in the hologram recording medium by applying object light from a predetermined direction via a focusing optical system that provides a predetermined diffusion angle.

The hologram recording medium in the first embodiment can therefore record multiple pieces of image information and allows a viewer to view each of the multiple pieces of image information from a predetermined viewing direction within a predetermined angular range. Further, the hologram recording medium in the first embodiment can record multiple pieces of image information expressed in a planar form, such as characters and barcodes, (hereinafter referred as appropriate to as 2D information, and three-dimensional image information on a stereoscopic shape is hereinafter referred as appropriate to as 3D information) and reproduce respective sharp images.

### [Exemplary Configuration of Manufacturing Apparatus]

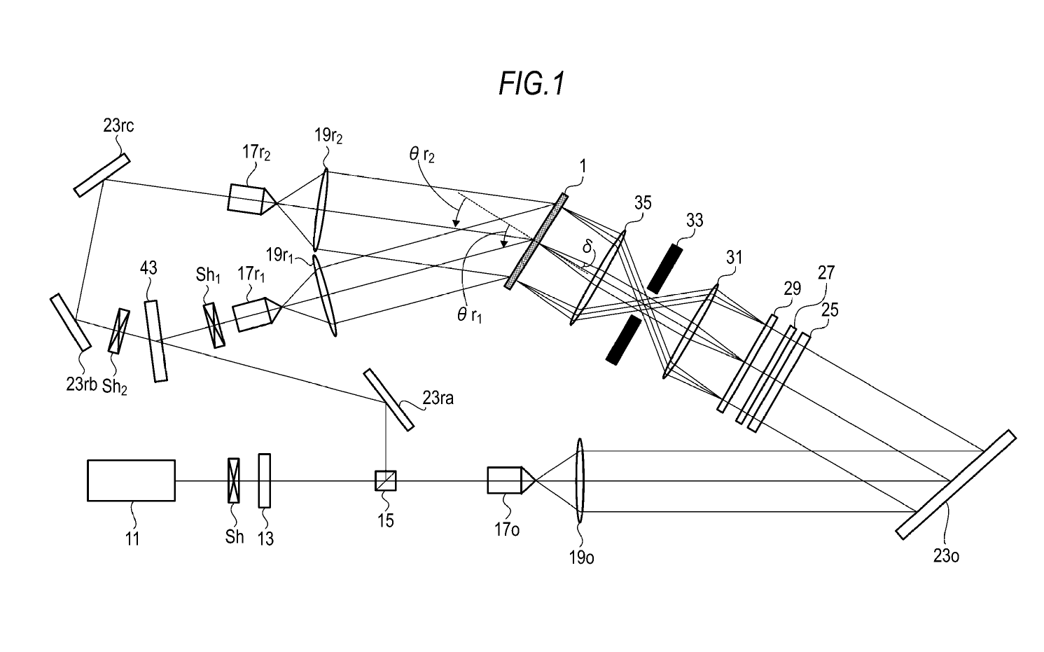

A method for manufacturing a hologram recording medium having holographic 2D information recorded therein will first be described with reference to FIG. 1.

FIG. 1 shows an exemplary configuration (a first exemplary configuration) of an apparatus for manufacturing a hologram recording medium. In the exemplary configuration shown in FIG. 1, a laser light source 11, a shutter Sh, a half-wave plate 13, and a polarizing beam splitter 15 are arranged in this order. Laser beams split by the polarizing beam splitter pass through a reference light optical system and an object light focusing optical system and impinge on a hologram recording medium 1.

### (Reference Light Optical System)

In the first exemplary configuration, two reference light optical systems are provided, as shown in FIG. 1. That is, one of the laser beams split by the polarizing beam splitter 15 and directed toward the reference light optical systems is reflected off a mirror 23ra and further split by a half-silvered mirror 43 into two laser beams. One of the split laser beams travels along a first optical path and impinges on the hologram recording medium 1, and the other laser beam travels along a second optical path and impinges on the hologram recording medium 1.

The first optical path has a shutter Sh₁, a spatial filter 17r₁, and a collimation lens 19r₁ arranged in this order. The second optical path has a shutter Sh₂, mirrors 23rb and 23rc, a spatial filter 17r₂, and a collimation lens 19r₂ arranged in this order. The angles of incidence θr₁ and θr₂ of the reference light beams are set at 45° and 22.5°, respectively.

### (Object Light Focusing Optical System)

The object light focusing optical system has a spatial filter 17o, a collimation lens 19o, a mirror 23o, a diffuser 25, a liquid crystal panel 27, a polarizer 29, a lens 31, a diaphragm 33, and a lens 35 arranged in this order. The liquid crystal panel 27 is connected to a liquid crystal driver (not shown), such as a microcomputer. The polarizer 29 is disposed on a light exiting side of the liquid crystal panel 27. The optical elements disposed along the optical path from the mirror 23o to the hologram recording medium 1 are attached to a rail or any other support member in predetermined positions.

The object light is incident on the hologram recording medium 1 approximately at right angles. That is, the angle of incidence θo of the object light is set, for example, at approximately 0°±5°. The reason for this is that the luminance of reproduced 2D information can be maximized in the vicinity of the direction of a normal to a recording surface of the hologram recording medium.

Image information is recorded in the hologram recording medium 1 as follows.

### (Reference Light)

First, the shutter Sh₁ is set in an OPEN position, and the shutter Sh₂ is set in a CLOSE position. The laser beam from the laser light source 11 passes through the half-wave plate 13 and impinges on the polarizing beam splitter 15. The half-wave plate 13 rotates the polarization plane of the laser beam by 90°. Part of the laser beam is reflected off the polarizing beam splitter 15 and enlarged by the spatial filter 17r₁. The laser beam from the spatial filter 17r₁ (that is, reference light) is incident on the collimation lens 19r₁. The laser beam is then collimated by the collimation lens 19r₁, and the hologram recording medium 1 having a layer made of a photosensitive material is irradiated with the collimated (S-polarized) laser beam.

### (Object Light)

The laser beam having passed through the polarizing beam splitter 15 is incident on the spatial filter 17o. The laser beam enlarged by the spatial filter 17o is collimated by the collimation lens 190 and incident on the mirror 23o.

The laser beam reflected off the mirror 23o passes through the diffuser 25 and impinges on the liquid crystal panel 27, which works as a spatial light modulator. The liquid crystal driver described above displays an image representing 2D information to be recorded on the liquid crystal panel 27. The liquid crystal panel 27 rotates the polarization plane of the laser beam, and the polarizer 29 transmits a necessary S-polarized component. The laser beam diffused by the diffuser 25 is narrowed by the diaphragm (mask) 33. The viewing angle at the time of viewing is thus defined.

The 2D information-carrying light having been produced by the liquid crystal panel 27 and having passed through the polarizer 29 is then incident on the hologram recording medium 1 via a focusing optical system formed of the projection lens 31, the diaphragm 33, and the projection lens 35.

An interference pattern formed by the incident laser beam, which is the reference light, and the laser beam containing the 2D information, which is the object light, is thus recorded in the hologram recording medium 1.

In an embodiment for producing a hologram recording medium, the diffusion angle provided by the diffuser 25 preferably has a small absolute value. Considering that an image of the recorded 2D information is captured in the direction of a normal to the recording surface of the hologram recording medium, the diffuser 25 preferably provides a diffusion angle that causes the full width at half maximum of the intensity of the diffracted light carrying the reproduced 2D information to be 8° or smaller. An experiment in which a typical diffusion light source is used to illuminate a hologram recording medium has shown that when a full width at half maximum of the diffracted light intensity is 8° or smaller, multiple pieces of identification information can be read together with excellent sharpness and uniformity across an area over which the identification information are recorded (15 mm square, for example).

Specifically, in the medium manufacturing method, the absolute value of the diffusion angle is preferably 7° or smaller, more preferably 3° or smaller. The reason for this is that the viewing angle over which the 2D information recorded in the hologram recording medium is reproduced changes with the diffusion angle provided by the diffuser 25, as will be described later.

The reason why the diffusion angle is set to be smaller than a target full width at half maximum of the diffracted light intensity is that the degree of diffusion at the time of recording differs from the degree of diffusion at the time of reproduction due to scattering that occurs in the hologram recording medium itself, instability of polymerization when interference fringes are formed and hence the diffusion, and other factors.

The diffuser may alternatively be one that diffuses light by approximately ±20° only in the direction perpendicular to the plane of view of FIG. 1 but does not diffuse the light at all in the θo direction in FIG. 1. Still alternatively, the diffuser 25 may be omitted as necessary.

In the exemplary configuration shown in FIG. 1, the laser beam as the object light containing 2D information has a diffusion angle ±δ produced by the diffuser 25 disposed in the vicinity of the liquid crystal panel 27 and the diaphragm 33.

After the 2D information (first 2D information) is recorded, another piece of 2D information (second 2D information), which differs from the first 2D information, is recorded in the hologram recording medium 1.

Before the second 2D information is recorded, the shutter Sh₁ is set in the CLOSE position, and the shutter Sh₂ is set in the OPEN position. The spatial filter 17r₂ enlarges the laser beam when the shutter Sh₂ is set in the OPEN position at the time of light exposure. The laser beam from the spatial filter 17r₂ (that is, reference light) is incident on the collimation lens 19r₂. The (S-polarized) laser beam collimated by the collimation lens 19r₂ is then incident on the hologram recording medium 1 having the photosensitive material layer. The angle of incidence θr of the reference light to be incident on the hologram recording medium 1 is changed preferably with the angle of incidence θo of the object light to be incident on the hologram recording medium 1 unchanged. The reason for this is that considering that an image of the recorded 2D information is captured in the direction of a normal to the recording surface of the hologram recording medium, the luminance of the reproduced 2D information is preferably maximized in the vicinity of the direction of the normal to the recording surface of the hologram recording medium.

The angle of incidence θr₁ of the reference light is set at 45° when the first 2D information is recorded, whereas the angle of incidence θr₂ is preferably set at a value ranging from 10° to 35° when the second 2D information is recorded. The reason for this is, for example, not only that a reproduction apparatus including a light source that illuminates the hologram recording medium from a predetermined direction and an imaging device can be reduced in size because the light source and the imaging device can be disposed not to interfere with each other, but also that the amount of crosstalk between the first 2D information and the second 2D information can be reduced.

The reason why one of the angles of incidence of the reference light used to record the first 2D information is set at 45° is that the specification of the angle of incidence is determined in many cases on a precondition that a hologram is in general illuminated with light obliquely downward at an angle of approximately 45°±8° and the angle of incidence is determined by simply following the convention. The reason why the design of a hologram is generally performed based on the angle described above is that a hologram is in many cases illuminated with downward light, such as light from a ceiling illuminator or sunlight, and the downward illumination light incident at an angle smaller than the value described above is directly reflected off the hologram toward the eyes of the viewer and the reflected light makes it difficult for the viewer to view the hologram, whereas an angle of incidence of the downward illumination light greater than the value described above increases surface reflection but lowers light usage efficiency.

Alternatively, the angle of incidence θr₂ is preferably set at a value ranging from 55° to 80°. The reason for this is again that the amount of crosstalk between the first 2D information and the second 2D information can be reduced.

The liquid crystal panel 27 displays an image representing the second 2D information, and the hologram recording medium 1 is irradiated with the reference light and the object light. That is, an interference pattern formed by the incident laser beam, which is the reference light, and the laser beam containing the second 2D information, which is the object light, is recorded in the hologram recording medium 1.

In the example shown in FIG. 1, two reference light optical paths are provided. Alternatively, three or more reference light optical paths may be provided, and the light exposure is performed multiple times corresponding to the number of reference light optical paths. Repeating the steps described above allows multiple different pieces of image information to be recorded in the hologram recording medium. In this case, to record the individual pieces of image information, the diffuser 25 and the diaphragm 33 may be changed so that the viewing angles over which the individual images are reproduced are changed, or the wavelength of the laser beam to be used may be changed.

### [Hologram Recording Medium Having 2D Information Recorded Therein]

The hologram recording medium produced by using the manufacturing method described above has multiple pieces of information recorded therein. When the hologram recording medium is illuminated with light at a predetermined angle, the corresponding one of the multiple pieces of recorded information is reproduced and forms a reproduced image with the full width at half maximum of the diffracted light intensity defined. The multiple pieces of information are so reproduced that multiple images will not be produced.

### (Reproduction of Recorded Information)

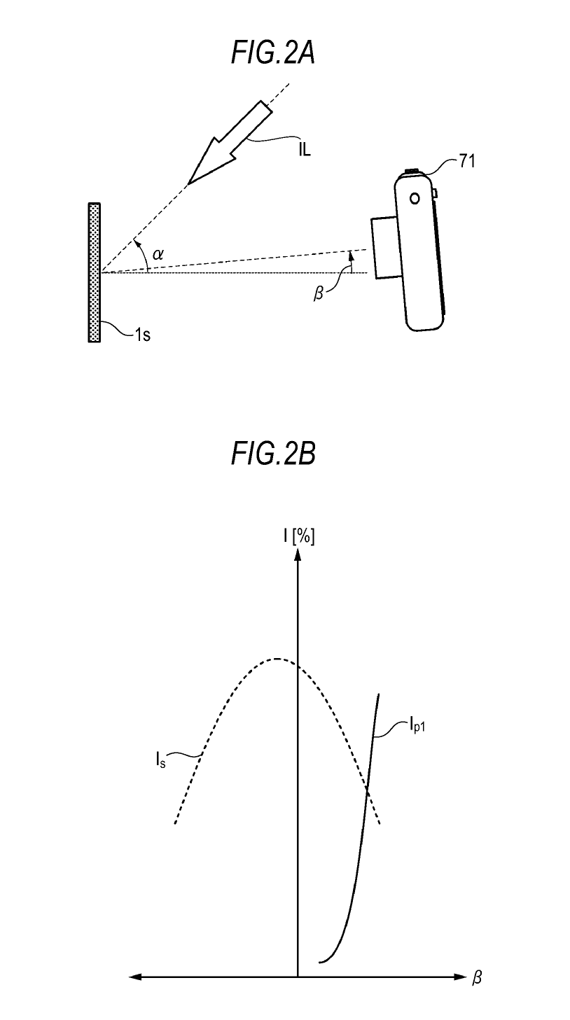

FIGS. 2A and 2B, 3A and 3B, and 4A and 4B describe the diffracted light intensity of an image reproduced from a hologram recording medium 1s. It is assumed now that the hologram recording medium 1s has image information S and 2D information P1 superimposed and recorded therein, and that the image information S is recorded with the diffusion angle δ of the object light not particularly limited whereas the 2D information P1 is recorded with the diffusion angle δ of the object light defined. It is also assumed that the angle of incidence θr₁ of the reference light used to record the image information S is 45° and the angle of incidence θr₂ of the reference light used to record the 2D information P1 is 22°. It is further assumed that the angle of incidence θo of the object light is approximately 0° in both cases.

FIG. 2A shows a case where the hologram recording medium 1s is irradiated with white illumination light IL at an angle α=45°. FIG. 2B shows the diffracted light intensity of a reproduced image captured by an imaging apparatus 71.

FIG. 2B diagrammatically shows the diffracted light intensity of a reproduced image. In FIG. 2B, the broken line Iₛ represents the diffracted light intensity associated with the image information S, and the solid line I_{P1} represents the diffracted light intensity associated with the 2D information P1.

Since the angle of incidence α of the illumination light IL is 45°, a peak of the diffracted light intensity associated with the image information S appears in the vicinity of the direction of a normal (η=0°) dropped to the recording surface of the hologram recording medium 1s, as shown in FIG. 2B. The vicinity used herein preferably ranges from −10° to +10°.

That is, when a viewer faces and views the hologram recording medium 1s, the viewer can recognize the image information S. On the other hand, the peak of the diffracted light intensity associated with the 2D information P1 does not appear in the vicinity of the direction of the normal (β=0°) dropped to the recording surface of the hologram recording medium 1s. The 2D information P1 therefore does not prevent the viewer from viewing the image information S.

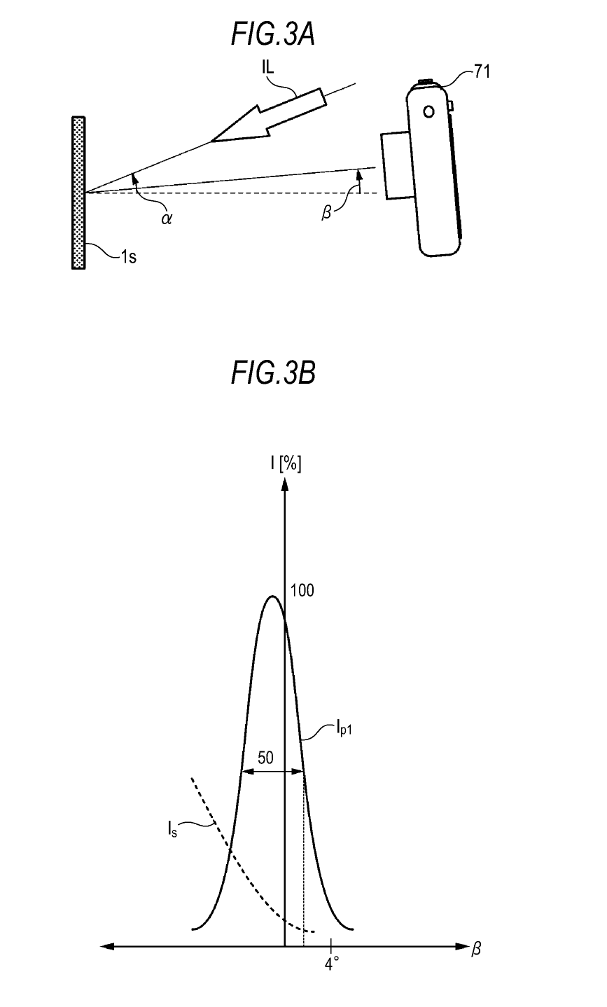

FIG. 3A shows a case where the hologram recording medium 1s is irradiated with white illumination light IL at an angle α=22°. FIG. 3B shows the diffracted light intensity of a reproduced image captured by the imaging apparatus 71.

FIG. 3B diagrammatically shows the diffracted light intensity of a reproduced image. In FIG. 3B, the broken line Iₛ represents the diffracted light intensity associated with the image information S, and the solid line I_{P1} represents the diffracted light intensity associated with the 2D information P1.

Since the angle of incidence a of the illumination light IL is 22°, a peak of the diffracted light intensity associated with the 2D information P1 appears in the vicinity of the direction of a normal (β=0°) dropped to the recording surface of the hologram recording medium 1s, as shown in FIG. 3B. That is, when the viewer faces and views the hologram recording medium 1s, the viewer can recognize the 2D information P1. The full width at half maximum of the diffracted light intensity associated with the 2D information P1 is preferably 8° or smaller, as shown in FIG. 3B.

Consider next a hologram recording medium is having 2D information P2 recorded therein instead of the 2D information P1 by setting the angle of incidence θr of the reference light at 67°.

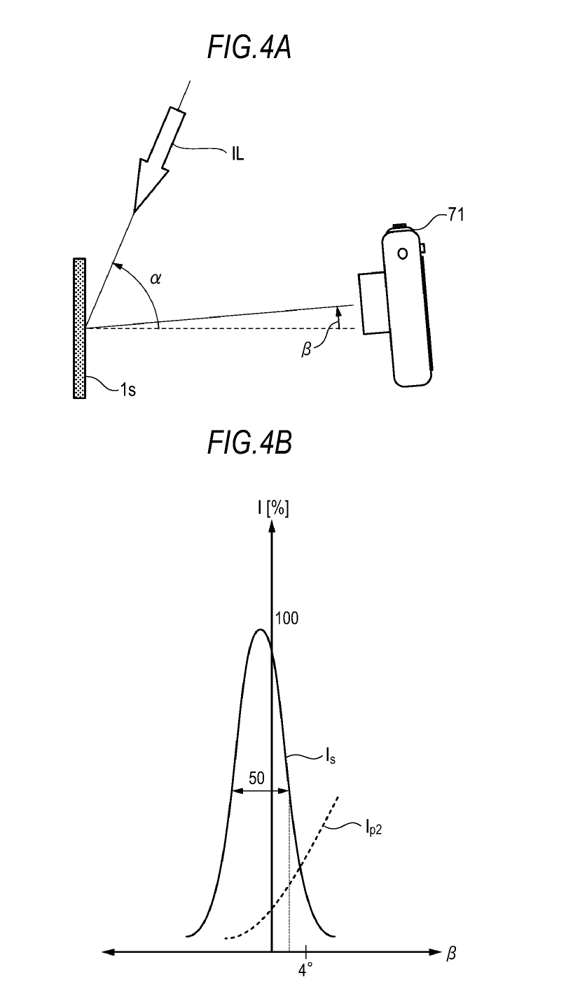

FIG. 4A shows a case where the hologram recording medium 1s is irradiated with white illumination light IL at an angle α=67°. FIG. 4B shows the diffracted light intensity of a reproduced image captured by the imaging apparatus 71.

FIG. 4B diagrammatically shows the diffracted light intensity of a reproduced image. In FIG. 4B, the broken line Iₛ represents the diffracted light intensity associated with the image information S, and the solid line I_{P2} represents the diffracted light intensity associated with the 2D information P2.

Since the angle of incidence α of the illumination light IL is 67°, a peak of the diffracted light intensity associated with the 2D information P2 appears in the vicinity of the direction of a normal (β=0°) dropped to the recording surface of the hologram recording medium 1s, as shown in FIG. 4B. That is, when the viewer faces and views the hologram recording medium 1s, the viewer can recognize the 2D information P2. The full width at half maximum of the diffracted light intensity associated with the 2D information P2 is preferably 8° or smaller, as shown in FIG. 4B.

The angles of incidence θr of the reference light beams used to record the respective pieces of information may alternatively be set as follows: One of the angles of incidence θr is 45°, and the other angle of incidence θr is −45° (θr=315°). In this case, since the amount of crosstalk between reproduced images is small, the respective pieces of information may be recorded with the diffusion angles provided by the object light focusing optical system not particularly defined, provided that recorded information will not be machine-read.

When a hologram recording medium having information recorded therein by setting θr at 45° and −45° as upper and lower parallax directions of the hologram recording medium is hung on a wall or any other similar surface, the hologram recording medium is illuminated with, for example, light from a ceiling illuminator and either of the pieces of information is reproduced. The hologram recording medium is then hung on the wall upside down, and the other information is reproduced. When it is difficult to hang the hologram recording medium upside down (when the hologram recording medium is, for example, attached to a large, heavy box), the other information can be readily viewed by illuminating the hologram obliquely upward at 45° with light from a torch or any other suitable device that emits light brighter than the light from the ceiling illuminator.

In either of the cases described above, either of the diffracted light intensities in the vicinity of the direction of the normal to the hologram recording medium is preferably at least five times greater than the other diffracted light intensity. In this way, each of the reproduced images can be clearly recognized.

### (Control of Viewing Angle)

As described with reference to FIGS. 2A and 2B, 3A and 3B, and 4A and 4B, by defining the diffusion angle provided by the object light focusing optical system, a hologram recording medium can be so produced that information visible only by a viewer within a predetermined angular range is recorded. At the time of reproduction, a replicated hologram recording medium 1 is illuminated with the illumination light IL at an angle of incidence α, as shown in FIG. 5. The viewing angle over which an image reproduced from the hologram recording medium is viewed has a width ±δ.

### (Localization of 2D Information)

According to the exemplary configuration shown in FIG. 1, image information expressed in a planar shape (2D information) is recorded in the hologram recording medium 1. The 2D information is formed, for example, of characters, numbers, symbols, figures, patterns, one-dimensional barcodes, two-dimensional barcodes, or any combination thereof. The 2D information is directly localized in a very shallow position from the recording surface of the hologram recording medium 1 by defining the diffusion angle provided by the object light focusing optical system. The depth at which the 2D information is localized can be set arbitrarily, preferably 2 mm or smaller, by using image processing or setting the position of the diffuser.

When the position where image information is localized is far away from the recording surface, multiple images are disadvantageously reproduced when a diffusion light source illuminates the hologram recording medium, resulting in degradation in sharpness of a reproduced image. In this case, a point light source allows 2D information to be reproduced sharply, whereas reproduced character information disadvantageously forms multiple images when the hologram recording medium is viewed, for example, under cloudy weather. That is, a sharp image will not be reproduced, and it is therefore very difficult to machine-read 2D information.

In the example described above, image information is not recorded in the hologram recording medium 1 in a contact copying process. The reason for this is that, for example, when character information is recorded in a planar shape in a contact copying process, the fact that a hologram master plate has a certain thickness causes the character information to be disadvantageously localized at a certain depth from the recording surface of the hologram recording medium.

As described above, to holographically record 2D information, it is effective to define the diffusion angle provided by the object light focusing optical system, that is, set the viewing angle over which a reproduced image of the 2D information is viewed at a small value.

### (Switching Reproduced Image)

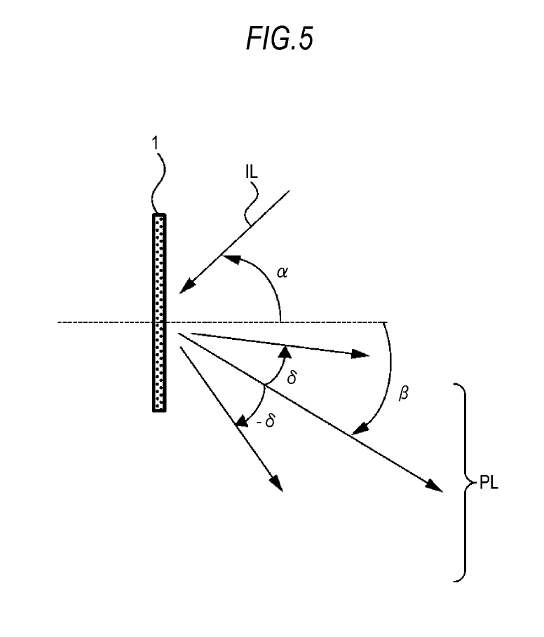

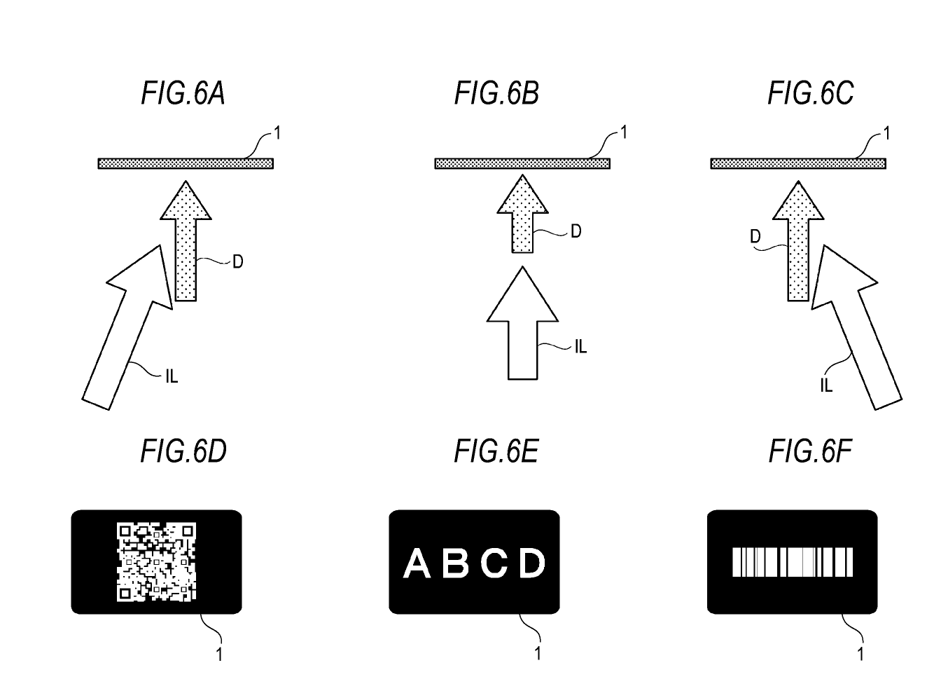

FIGS. 6A to 6F, 7A to 7F, and 8A to 8F describe the relationship of the direction in which illumination light is incident, the direction in which a hologram recording medium is viewed, and the orientation of the hologram recording medium versus a reproduced image. In FIGS. 6A to 6F, 7A to 7F, and 8A to 8F, 2D information formed of a two-dimensional barcode, character information, and a one-dimensional barcode is recorded in the hologram recording medium 1. The pieces of 2D information are recorded with the angles of incidence θr of the reference light beams different from one another and the full width of half maximum of the diffracted light intensity of each reproduced image being 8° or smaller.

FIGS. 6A to 6F show reproduced images with the direction in which the hologram recording medium is viewed and the orientation of the hologram recording medium fixed and the direction in which the illumination light is incident changed. First, The direction in which the illumination light IL is incident, the direction D in which the hologram recording medium 1 is viewed, and the orientation of the hologram recording medium 1 are set as shown FIG. 6A. When the hologram recording medium in this state is viewed, the two-dimensional barcode is recognized, as shown in FIG. 6D. When the direction in which the illumination light IL is incident is switched to the one shown in FIG. 6B, the image reproduced from the hologram recording medium 1 is switched to the character information as shown in FIG. 6E. Further, when the direction in which the illumination light IL is incident is switched to the one shown in FIG. 6C, the reproduced image is switched to the one-dimensional barcode as shown in FIG. 6F.

As described above, the 2D information reproduced from the hologram recording medium 1 can be switched in accordance with the direction in which the illumination light IL is incident.

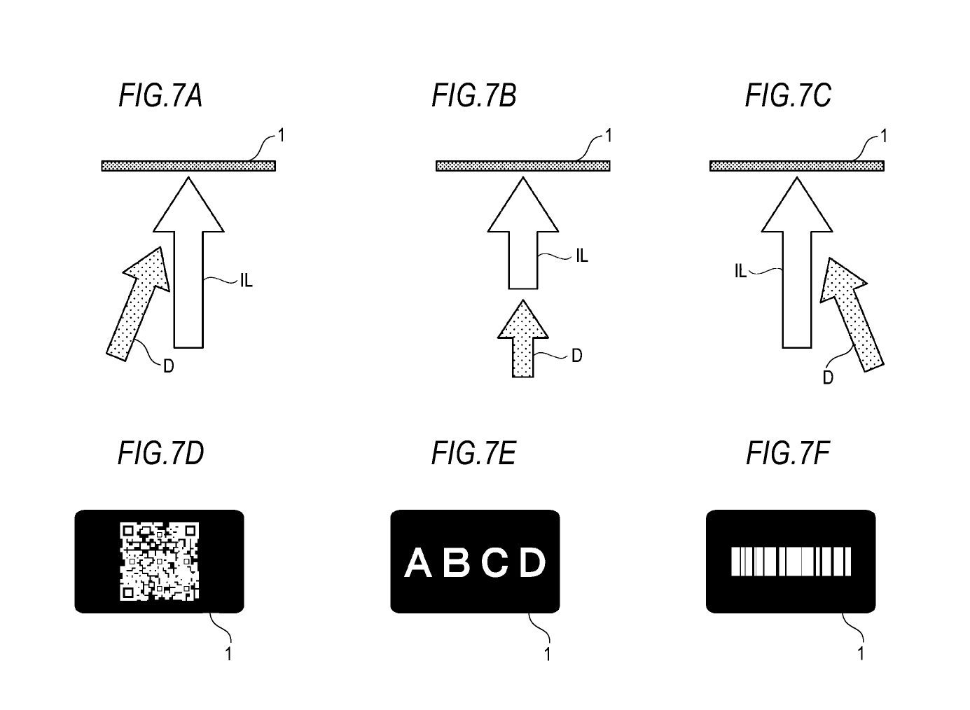

FIGS. 7A to 7F show reproduced images with the direction in which the illumination light is incident and the orientation of the hologram recording medium fixed and the direction in which the hologram recording medium is viewed changed. When the direction in which the illumination light IL is incident, the direction D in which the hologram recording medium 1 is viewed, and the orientation of the hologram recording medium 1 are switched to any of those shown in FIGS. 7A, 7B, and 7C, the reproduced image is switched to the corresponding one of those shown in FIGS. 7D, 7E, and 7F.

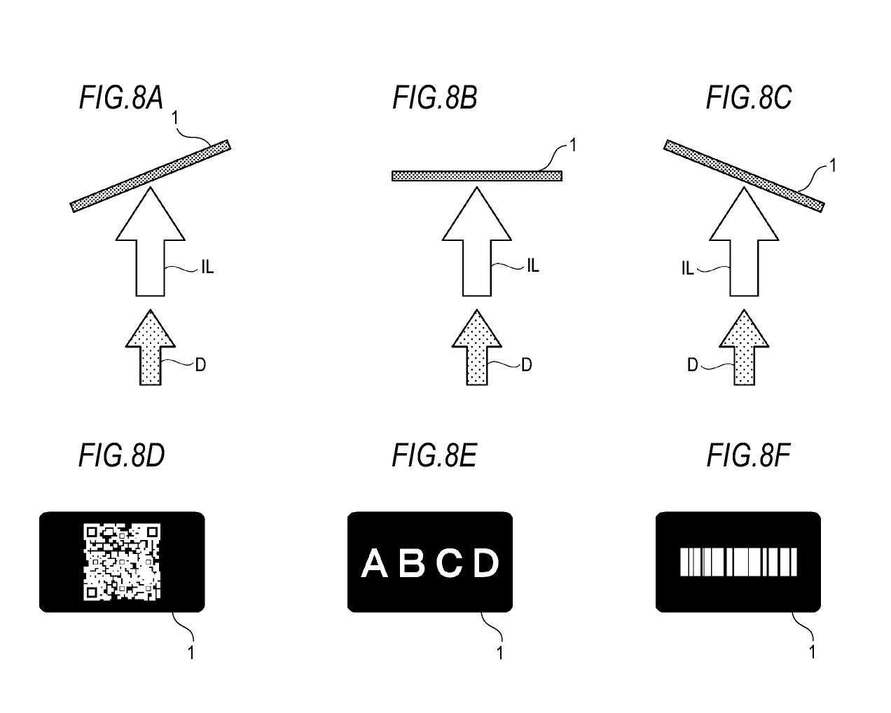

FIGS. 8A to 8F show reproduced images with the direction in which the illumination light is incident and the direction in which the hologram recording medium is viewed fixed and the orientation of the hologram recording medium changed. When the direction in which the illumination light IL is incident, the direction D in which the hologram recording medium 1 is viewed, and the orientation of the hologram recording medium 1 are switched to any of those shown in FIGS. 8A, 8B, and 8C, the reproduced image is switched to the corresponding one of those shown in FIGS. 8D, 8E, and 8F.

As described above, among the direction in which the illumination light IL is incident, the direction D in which the hologram recording medium 1 is viewed, and the orientation of the hologram recording medium 1, fixing two of them and switching the remaining one allows information reproduced from the hologram recording medium 1 to be changed.

### Second Exemplary Configuration of First Embodiment

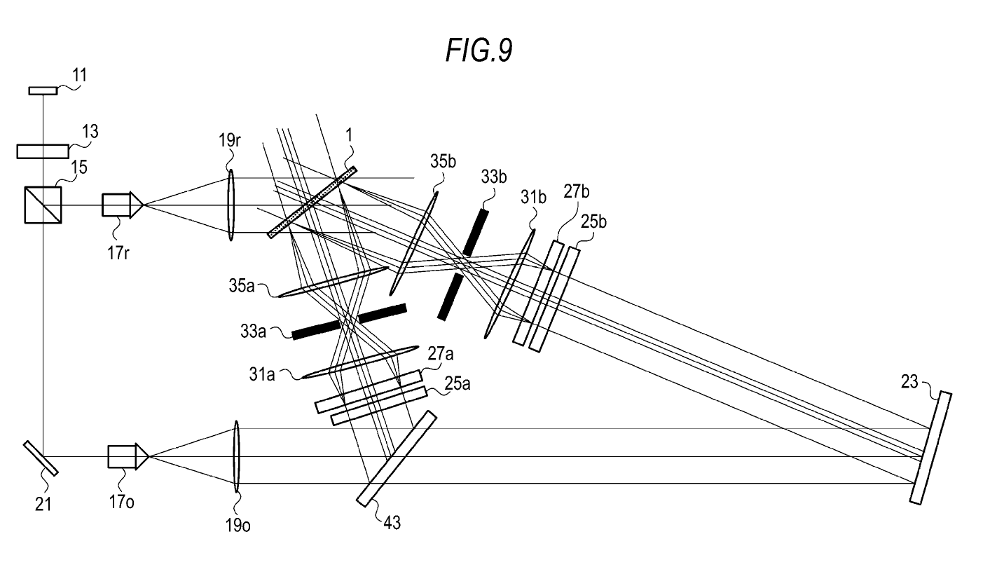

FIG. 9 shows a second exemplary configuration of the apparatus for manufacturing a hologram recording medium. The second exemplary configuration differs from the first exemplary configuration, in which two reference light optical paths are provided, in that two object light optical paths are provided. That is, the half-silvered mirror 43 is disposed in the optical path of the laser beam having passed through the polarizing beam splitter 15 to further split the laser beam into first and second split laser beams. In the second exemplary configuration, two object light focusing optical systems are thus provided.

The laser beam having passed through the half-silvered mirror 43 is incident on a mirror 23, as shown in FIG. 9. The laser beam reflected off the mirror 23 is the second split laser beam.

The first split laser beam passes through a diffuser 25a and impinges on a liquid crystal panel 27a (including a polarizer), as in the first exemplary configuration. A 2D information-carrying image displayed on the liquid crystal panel 27a is focused on a hologram recording medium 1 via a focusing optical system (projection lenses 31a and 35a and diaphragm 33a).

On the other hand, the second split laser beam passes through a diffuser 25b and impinges on a liquid crystal panel 27b (including a polarizer). A 2D information-carrying image displayed on the liquid crystal panel 27b is focused on the hologram recording medium 1 via a focusing optical system (projection lenses 31b and 35b and diaphragm 33b).

The angle of incidence of the 2D information-carrying light produced from the first split laser beam with respect to the hologram recording medium 1 differs from the angle of incidence of the 2D information-carrying light produced from the second split laser beam with respect to the hologram recording medium 1. A viewpoint from which the 2D information produced by the liquid crystal panel 27a is viewed can therefore be different from a viewpoint from which the 2D information produced by the liquid crystal panel 27b is viewed.

The hologram recording medium 1 is irradiated with the two split laser beams at the same timing. Alternatively, the hologram recording medium 1 maybe irradiated with the two split laser beams in a temporally sequential manner. Still alternatively, three or more split laser beams may be used.

According to the second exemplary configuration of the first embodiment, two types of 2D information viewed from two viewpoints can be simultaneously recorded in the hologram recording medium 1.

### Third Exemplary Configuration of First Embodiment

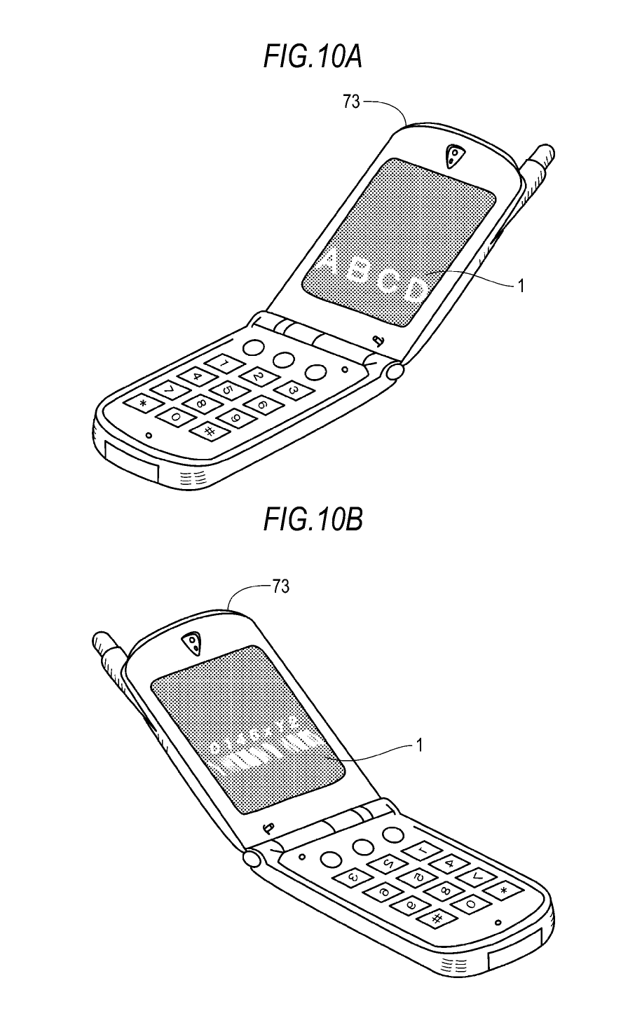

FIGS. 10A and 10B show an exemplary configuration of the hologram recording medium. A third exemplary configuration differs from the first exemplary configuration in that a hologram recording medium in which 2D information is recorded is a transmissive volume hologram.

FIGS. 10A and 10B show an example in which a hologram recording medium 1 is attached to a display of a mobile phone 73. For example, two pieces of 2D information are recorded in the hologram recording medium 1. One of the two pieces of 2D information is character information and the other is a combination of character information and a one-dimensional barcode.

Reproduced 2D information can be changed by changing the angle at which the display is viewed, as shown in FIGS. 10A and 10B. The diffracted light intensity of a reproduced image viewed by a viewer who faces the display can be set at a small value by adjusting as appropriate the angle of incidence of the reference light at the time of recording. The hologram recording medium 1 attached to the display therefore does not prevent the user of the mobile phone 73 from operating it.

Multiple pieces of information recorded in the hologram recording medium 1 may alternatively be reproduced by illuminating the hologram recording medium 1 from specific directions. The thus configured hologram recording medium 1 can be attached, for example, to a transparent show window and the illumination light beam is switched among those from a variety of directions, whereby the show window itself can be an advertisement medium that attracts consumers.

According to the third exemplary configuration of the first embodiment, the hologram recording medium does not prevent information displayed or being displayed on an object to which the hologram recording medium is attached from being viewed, allowing a variety of objects to be provided with decorative design, management information, product information, and other information.

The object to which the hologram recording medium 1 is attached can be not only the display of a mobile phone but also, for example, the displays of a personal computer, a smart phone, a personal digital assistant or personal data assistance (PDA), and a portable video game console. The object to which the hologram recording medium 1 is attached may also be an ID photo, a product package, a business card, a student identification card, and other items.

### 2. Second Embodiment

A second embodiment will next be described.

According to the second embodiment, multiple pieces of image information are recorded in a hologram recording medium. The multiple pieces of image information include 3D information and 2D information. Among the multiple pieces of image information, the 2D information is directly focused on the surface of the hologram recording medium. Among the multiple pieces of image information, the 2D information is recorded in the hologram recording medium by using object light from a predetermined direction via a focusing optical system that provides a predetermined diffusion angle.

The 3D information and the 2D information, the latter of which is viewable in a predetermined viewing direction within a predetermined angular range, can therefore be recorded in the hologram recording medium.

### [Exemplary Configuration of Manufacturing Apparatus]

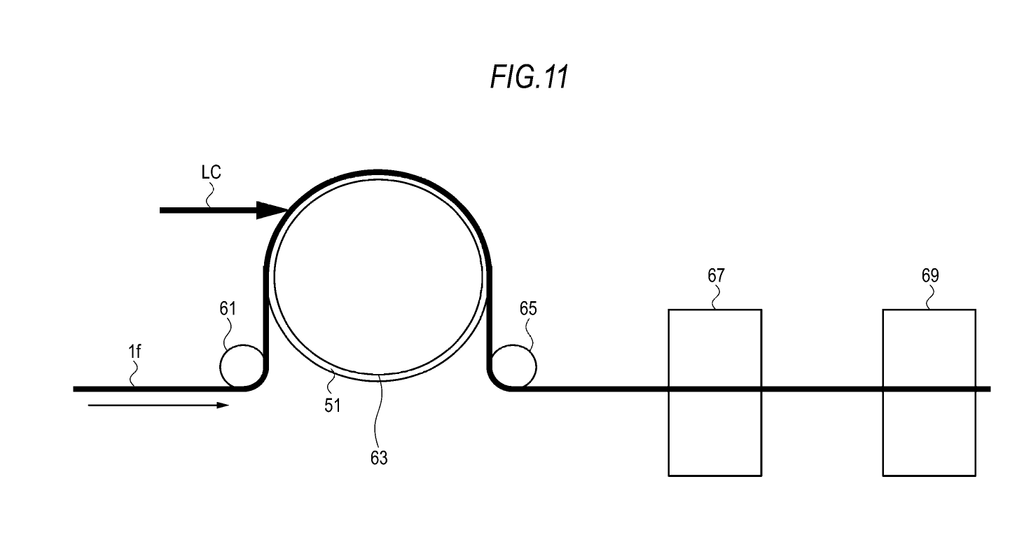

A method for manufacturing a hologram recording medium having 3D information and 2D information recorded therein will be described with reference to FIG. 11.

FIG. 11 shows an exemplary configuration of the apparatus for manufacturing a hologram recording medium. In the exemplary configuration shown in FIG. 11, 3D information recorded in a hologram master plate 51 is copied to a hologram recording medium in a contact copying process, and 2D information is further recorded as superimposed additional information. In the exemplary configuration shown in FIG. 11, 2D information is recorded as additional information by using a laser beam different from a laser beam used in the contact copying process.

A light source (not shown) of a copying laser beam LC, rollers 61, 63, and 65, a light exposure section 67, and a UV fixation section 69 are arranged in this order, as shown in FIG. 11. The hologram master plate 51 is attached around the roller 63. The hologram master plate 51 contains, for example, horizontally continuous parallax images.

A hologram recording film 1f is fed from a roller (not shown) and transported between the rollers 61 and 63, the rollers 65 and 63, the light exposure section 67, and the UV fixation section 69 in this order. The hologram recording film is produced by applying a photosensitive material on a light transmissive base film.

The hologram recording film 1f fed from the feeding roller is bound around the roller 63. The hologram recording film 1f in intimate contact with the hologram master plate 51 is irradiated with the copying laser beam LC, and the hologram in the hologram master plate 51 is copied to the hologram recording film 1f. Specifically, when the feeding of the hologram recording film 1f is stopped, a shutter associated with the light source (not shown) of the copying laser beam LC is opened at the same time, and the copying laser beam LC is applied.

The hologram recording film 1f to which the hologram has been copied is transported to the light exposure section 67, where 2D information is superimposed and recorded. The configuration of 2D information recording can be the same as that in the first embodiment.

The hologram recording film 1f having the 3D information and the 2D information recorded therein is transported from the light exposure section 67 toward the UV fixation section 69. The steps described above may alternatively be carried out as follows: The 2D information is first recorded; the hologram is then copied in a contact copying process; and the fixation is performed.

### Second Exemplary Configuration of Second Embodiment

A second exemplary configuration of the second embodiment differs from the configuration shown in FIG. 1 in that a hologram recording medium having 3D information recorded therein in advance is used to further record 2D information as superimposed additional information.

The exemplary configuration of the manufacturing apparatus described in the first embodiment is used without any modification to manufacture the hologram recording medium in the second exemplary configuration of the second embodiment. The 3D information is recorded before the monomer M shown in FIGS. 29A to 29C is polymerized, and the monomer M is polymerized after the 2D information is recorded as additional information. That is, after the 2D information is recorded in the hologram recording medium 1 having the 3D information recorded therein in advance, the images are fixed.

According to the second exemplary configuration of the second embodiment, 3D information and 2D information, the latter of which is viewable in a predetermined viewing direction within a predetermined angular range, can be recorded in a hologram recording medium.

### 3. Third Embodiment

A third embodiment will next be described.

According to the third embodiment, a hologram reproduction apparatus is so configured that an object to be viewed can be positioned on a viewing stage. The object to be viewed is irradiated with predetermined illumination light from a predetermined direction. The illumination light is configured not to travel directly toward a viewer. The viewer views the object to be viewed through an optical opening in a predetermined direction.

Individual pieces of recorded information can therefore be selectively reproduced from a hologram recording medium, and the viewer can view the individual pieces of recorded information readily, quickly, and reliably.

### [Exemplary Configuration of Hologram Reproduction Apparatus]

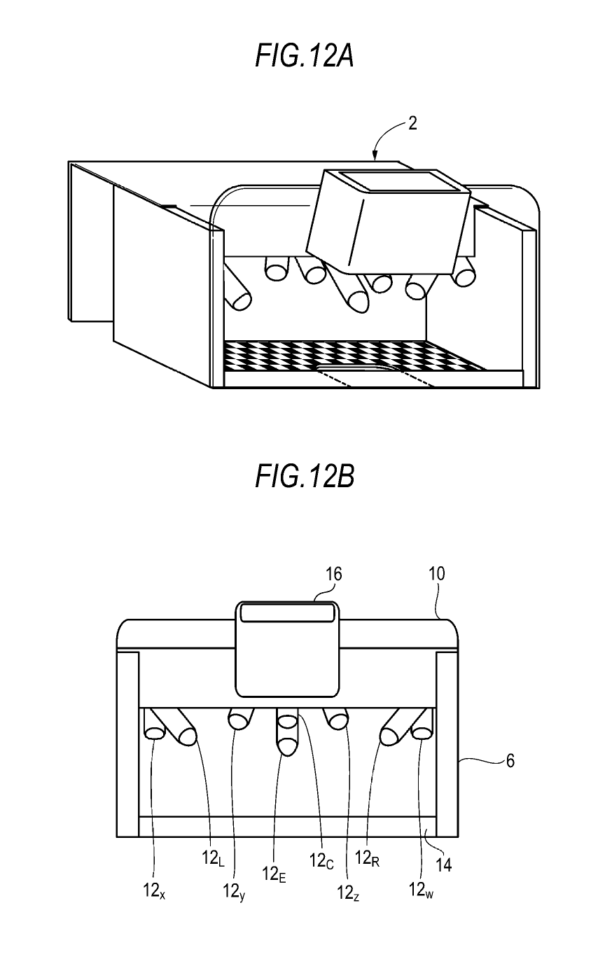

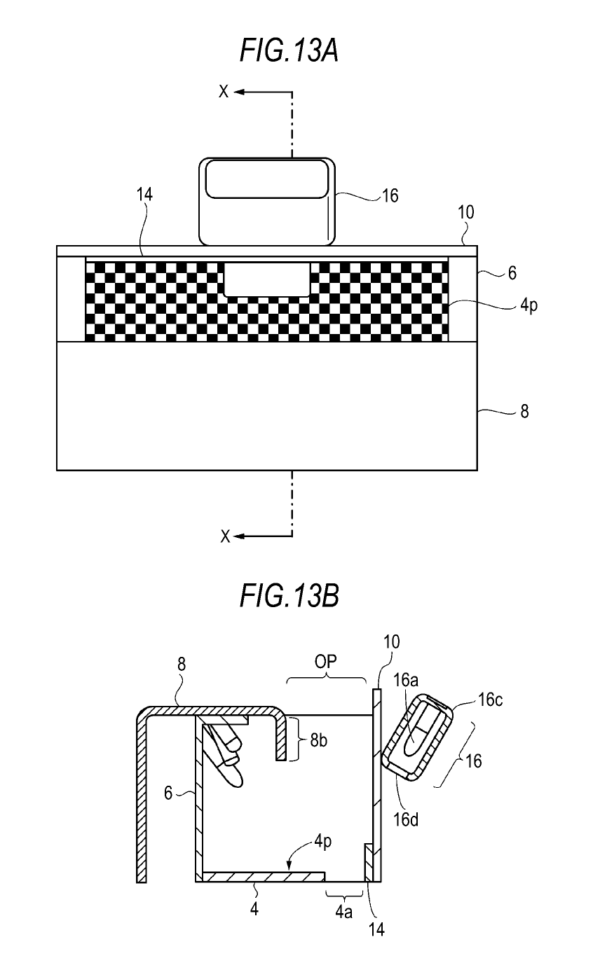

FIGS. 12A and 12B and FIGS. 13A and 13B show an exemplary configuration (first exemplary configuration) of an apparatus for reproducing a hologram recording medium. FIG. 12A is a perspective view showing an exemplary configuration of the hologram reproduction apparatus. FIG. 12B is a front view showing the exemplary configuration of the hologram reproduction apparatus. FIG. 13A is a plan view showing the exemplary configuration of the hologram reproduction apparatus. FIG. 13B is a cross-sectional view taken along the line X-X shown in FIG. 13A.

In the exemplary configuration shown in FIGS. 12A and 12B and FIGS. 13A and 13B, a hologram reproduction apparatus 2 has a substantially box shape. The bottom of the hologram reproduction apparatus 2 forms a viewing stage 4. A support member 6 that forms side surfaces and a rear surface is fixed to the viewing stage 4. A light blocking member 8 is placed on the support member 6 and forms an upper surface of the hologram reproduction apparatus 2. A transparent member 10 forms a front surface of the hologram reproduction apparatus 2. The components described above form a housing of the hologram reproduction apparatus, and a plurality of light sources 12_{L}, 12_{C}, 12_{R}, 12_{E} and 12ₓ, 12_{y}, 12_{w}, 12_{z} are disposed in the housing.

An opening 4a is provided in the viewing stage 4. The opening 4a is provided to position a hologram recording medium 1, which is an object to be viewed. Further, a high-frequency, brightness difference pattern 4p formed, for example, in a printing process is provided. The high-frequency pattern 4p is used when an imaging apparatus captures an image of the hologram recording medium 1, as will be described later. The plurality of light sources 12_{L}, 12_{C}, 12_{R}, 12_{E} and 12ₓ, 12_{y}, 12_{w}, 12_{z} are so fixed to the support member 6 that they emit light in predetermined directions.

The light blocking member 8 includes a light blocking portion 8b formed by bending part of the light blocking member 8 downward, resulting in an optical opening OP above the opening 4a provided in the viewing stage 4. The light blocking portion 8b may alternatively be a member separate from the light blocking member 8. The optical opening may be formed with no member disposed therein or with a light transmissive member transparent enough not to prevent the viewer from viewing the hologram recording medium 1 disposed in the opening. The light blocking member 8 is provided to prevent the light emitted from the plurality of light sources from leaking through the optical opening OP toward the viewer.

The hologram recording medium 1 is viewed and imaged as follows: The hologram reproduction apparatus 2 is so placed that the hologram recording medium 1 positioned in the opening 4a is visible, and the hologram recording medium 1 is viewed with the eyes of the viewer and imaged through the optical opening OP. In this example, the hologram recording medium 1 can be viewed and imaged in a direction substantially perpendicular to the surface of the hologram. The hologram recording medium 1 is desirably imaged in the vertical direction within a range of approximately ±10°. The reason for this is that an imaging device used to capture an image of the hologram is maintained parallel to the surface thereof across the area to be read, whereby the entire area is readily brought into focus and no trapezoidal distortion correction or other additional processing is necessary.

The plurality of light sources 12_{L}, 12_{C}, 12_{R}, 12_{E} and 12ₓ, 12_{y}, 12_{w}, 12_{z} are provided to selectively reproduce multiple pieces of information recorded in the hologram recording medium 1. That is, each of the light sources is oriented in a predetermined direction and emits light having a predetermined wavelength band. Each of the light sources is, for example, an LED (light emitting diode). As shown in FIG. 12B, the light sources 12_{L}, 12_{C}, and 12_{R}, which are white light LEDs for illumination purposes, face in a downward but rightward direction, a straight downward direction, and a downward but leftward direction respectively, and the light source 12_{E}, which is a red LED for illuminating an embossed hologram, is also disposed. Further, the light sources 12ₓ, 12_{y}, 12_{w}, and 12_{z}, which are white LEDs for illuminating the entire high-frequency pattern 4p, are disposed.

A mirror 14 is so disposed at a lower portion of the transparent member 10 that the reflection surface of the mirror 14 faces inward in the housing. The mirror 14 is used to illuminate the hologram recording medium 1 in a downward but leftward direction in FIG. 13B. That is, among the plurality of light sources, a predetermined light source (the central white LED light source 12_{C} for an illumination purpose, for example) is so oriented that the hologram recording medium 1 is illuminated with light emitted from the predetermined light source and reflected off the mirror 14.

A diffusion light source 16 that emits light passing through the transparent member 10 and illuminates the hologram recording medium 1 may further be provided. The diffusion light source 16 is formed, for example, of LED light sources 16a and 16b (LED light source 16b is not shown), an exterior shell 16c, and a diffuser 16d.

It is noted that the number of light sources, the type thereof, the combination thereof, and other factors described above are presented only by way of example, and that they are changed as appropriate in accordance with the types of information recorded in the hologram recording medium 1. The wavelength band of the light emitted from each of the light sources does not necessarily fall within a visible region, but may fall within a near infrared region, an infrared region, a near ultraviolet region, or an ultraviolet region. The hologram reproduction apparatus 2 preferably further includes a switch and a switching circuit for changing the light source that illuminates the hologram recording medium 1. A movable mirror may alternatively be disposed to reflect the light from any of the light sources so that the illumination direction can be changed or adjusted.

### (Viewing Hologram Having 2D Information Recorded Therein)

To machine-read a hologram recording medium 1 having multiple pieces of 2D information recorded therein, it is conceivable to provide illumination light sources in a reader and capture images of the hologram recording medium 1 at predetermined angles. Simply disposing LED light sources or any other suitable light sources in the reader, however, disadvantageously causes the diffracted light intensity to decrease in the portion other than the intersection of the line connecting the center of each of the light sources to the imaging apparatus and the hologram recording medium 1 and the vicinity of the intersection.

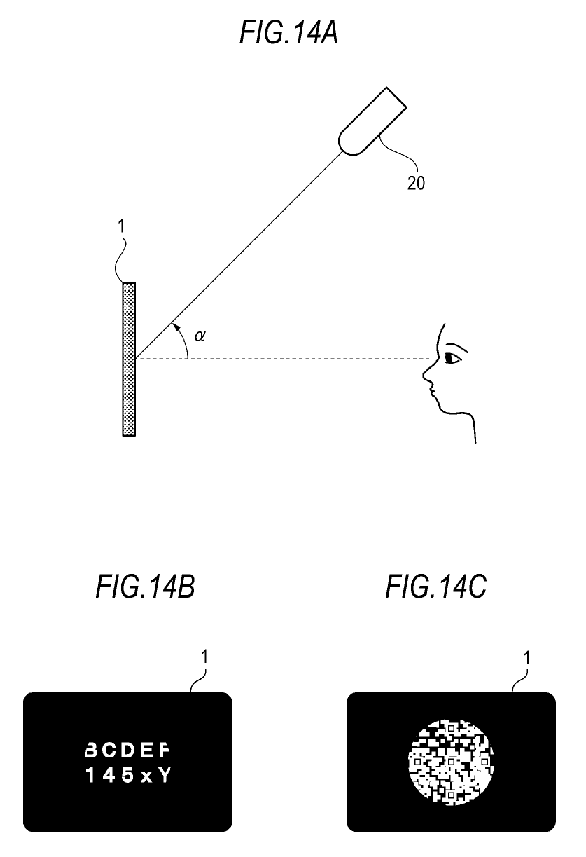

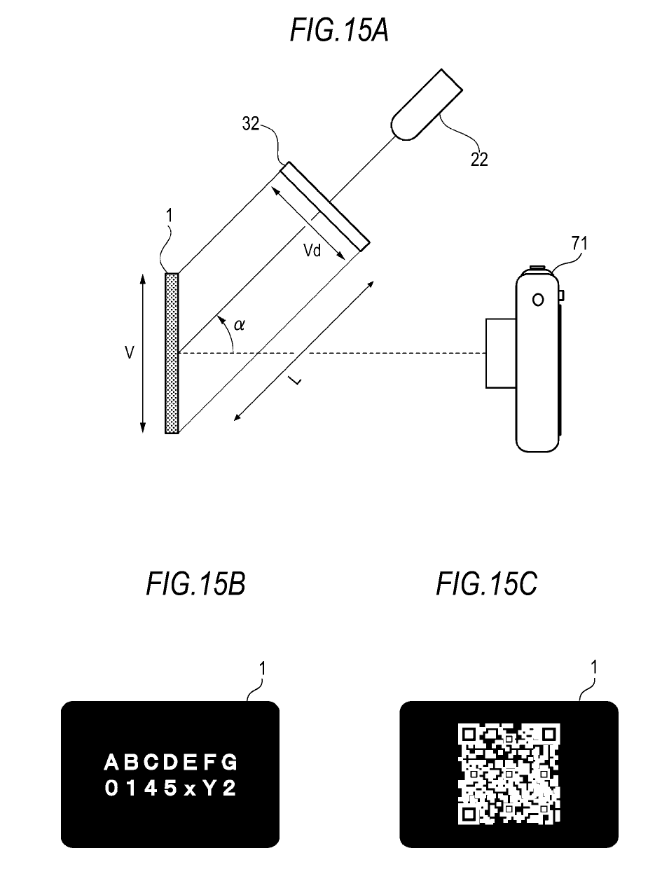

FIG. 14A is a diagrammatic view showing how an image is reproduced when a single LED light source 20 illuminates the hologram recording medium 1. FIG. 14B is a diagrammatic view showing a reproduced image viewed when character information recorded in the hologram recording medium 1 is reproduced by illuminating the hologram recording medium 1 at a predetermined angle. FIG. 14C is a diagrammatic view showing a reproduced image viewed when a two-dimensional barcode recorded in the hologram recording medium 1 is reproduced by illuminating the hologram recording medium 1 at another predetermined angle. The same holds true in FIGS. 15B and 15C to FIGS. 18B and 18C, which will be used in the following description. When only a limited portion of 2D information recorded in the hologram recording medium 1 is brightly reproduced as shown in FIGS. 14B and 14C, it is difficult to read the entire recorded information in a single operation.

### (Illumination Light Source)

A preferred example of the light source for illuminating the hologram recording medium 1 will be described below.

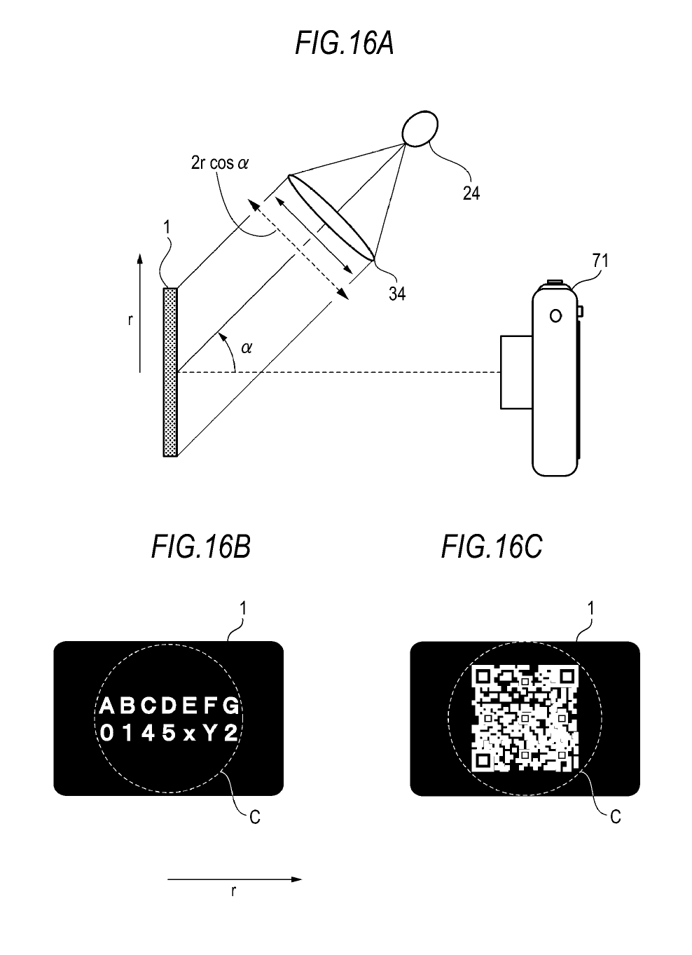

FIG. 15A describes an example of the light source for illuminating the hologram recording medium 1. In FIG. 15A, a light source 22, the hologram recording medium 1, and the imaging apparatus 71 are viewed sideways. The same hold true in FIGS. 16A to 18A, which will be used in the following description. In the example shown in FIG. 15A, a diffusion function component 32 is disposed in a position somewhere along a line connecting the light source 22 to the hologram recording medium 1. The diffusion function component 32 is, for example, a diffuser.

In FIG. 15A, reference character V denotes the longitudinal length of the area where 2D information is recorded. Reference character L denotes the distance between the diffusion function component 32 and the hologram recording medium 1. Reference character α denotes the angle between a normal dropped to the hologram and a line connecting the foot of the normal dropped to the hologram to the light source. In this case, the longitudinal length Vd of the diffusion function component 32 is preferably at least 75% of V×cos α. Further, the following relationship is preferably satisfied: V≦2L×tan β where ±β is a longitudinal diffusion angle provided by the diffusion function component 32. That is, the longitudinal diffusion range of the illumination light is set to be longer than or equal to the longitudinal length of the area where 2D information is recorded. The reason why V×cos α is multiplied by 75% is that a visual experiment has shown that the 2D information is successfully read when the length Vd is at least 0.75V×cos α although a desirable value thereof is at least V×cos α.

In this way, the entire recorded 2D information is clearly reproduced and the viewer can view the thus reproduced image, as shown in FIGS. 15B and 15C.

FIG. 16A describes an example of the light source for illuminating the hologram recording medium 1. In the example shown in FIG. 16A, a collimation lens 34 is disposed in a position somewhere along a line connecting a light source 24 to the hologram recording medium 1.

In FIG. 16A, reference character r denotes the radius of a circle C that encloses the area where 2D information is recorded, as shown in FIGS. 16B and 16C. Reference character a denotes the angle between a normal dropped to the hologram and a line connecting the foot of the normal dropped to the hologram to the light source. In this case, the aperture diameter of the collimation lens 34 is preferably at least 75% of 2r×cos α. The reason why 2r×cos α is multiplied by 75% is that a visual experiment has shown that the 2D information is successfully read when the aperture diameter is at least 0.75×2r×cos α although a desirable value thereof is at least 2r×cos α.

In this way, the entire recorded 2D information is clearly reproduced and the viewer can view the thus reproduced image, as shown in FIGS. 16B and 16C.

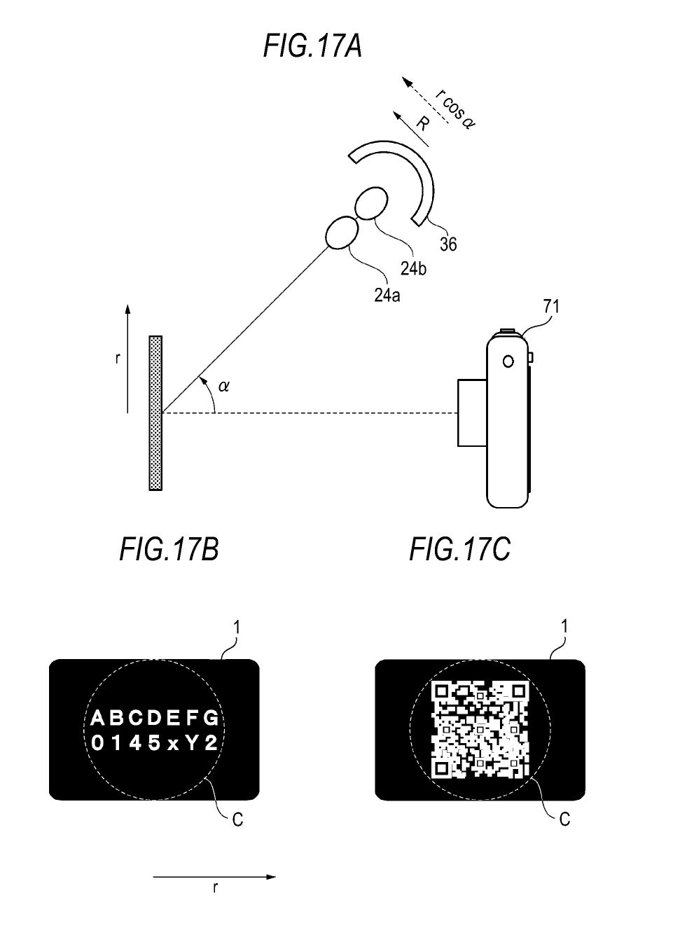

FIG. 17A describes an example of the light source for illuminating the hologram recording medium 1. In the example shown in FIG. 17A, a reflection plate 36 is disposed in a position somewhere along an extension of a line connecting light sources 24a and 24b to the hologram recording medium 1 on the opposite side of the light sources 24a and 24b to the hologram recording medium 1. The reflection plate 36 can, for example, be a concave mirror but is not limited thereto and any component that provides certain reflectance.

The surface of the reflection plate may not be smooth. The concave cross-sectional shape taken along a surface containing a line connecting the reflection plate 36 to the hologram recording medium 1 is not limited to an arcuate shape but maybe a parabolic shape, an elliptical shape, a free-form curved shape, a polygonal shape, part of any of the shapes described above, or a combination thereof. The reflection plate 36 may be a monolithic member or formed of a plurality of members.

In FIG. 17A, reference character r denotes the radius of a circle C that encloses the area where 2D information is recorded, as shown in FIGS. 17B and 17C. Reference character a denotes the angle between a normal dropped to the hologram and a line connecting the foot of the normal dropped to the hologram to the light sources. In this case, the radius R of a circle that encloses the contour of the cross-sectional shape of the reflection plate 36 on the side where the reflection plate 36 is open toward the hologram recording medium 1 in the direction perpendicular to the line connecting the light sources 24a and 24b to the hologram recording medium 1 is preferably at least 75% of r×cos α. The reason why r×cos α is multiplied by 75% is that a visual experiment has shown that the 2D information is successfully read when the radius R is at least 0.75r×cos α although a desirable value thereof is at least r×cos α.

In this way, the entire recorded 2D information is clearly reproduced and the viewer can view the thus reproduced image, as shown in FIGS. 17B and 17C.

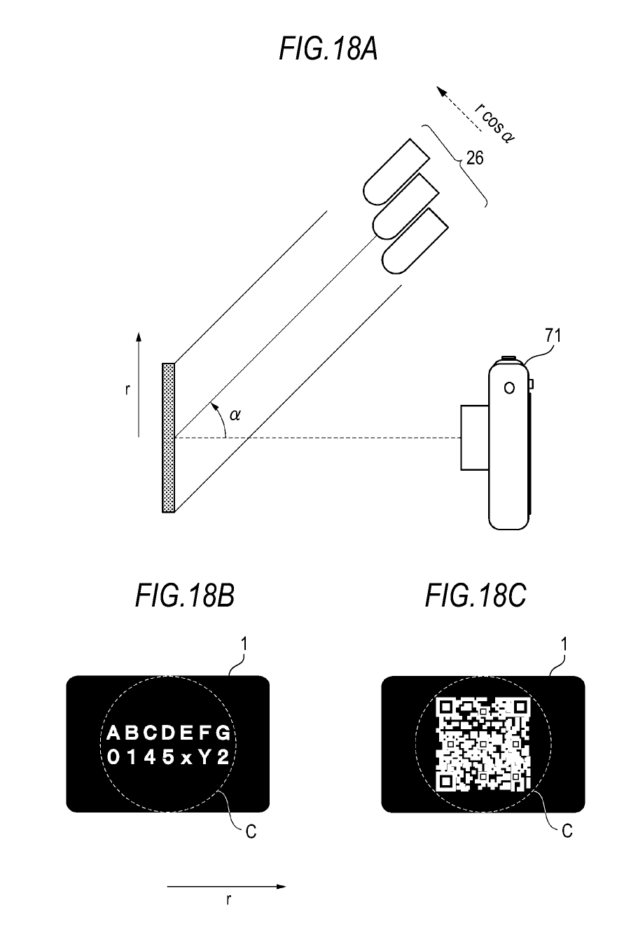

FIG. 18A describes an example of the light source for illuminating the hologram recording medium 1. In the example shown in FIG. 18A, the light source for illuminating the hologram recording medium 1 is a group of light sources 26 formed of a plurality of light sources.

In FIG. 18A, reference character r denotes the radius of a circle that encloses the area where 2D information is recorded, as shown in FIGS. 18B and 18C. Reference character a denotes the angle between a normal dropped to the hologram and a line connecting the foot of the normal dropped to the hologram to the group of light sources. In this case, the group of light sources 26 is preferably disposed in an area defined by a circle having a radius r×cos α in a cross section in the direction perpendicular to a line connecting the group of light sources to the hologram recording medium 1.

In this way, the entire recorded 2D information is clearly reproduced and the viewer can view the thus reproduced image, as shown in FIGS. 18B and 18C.

In the cases shown in FIGS. 16A to 16C to FIGS. 18A to 18C, it is preferable to further provide a light diffusion function component between the light source(s) and the hologram recording medium 1 in order to increase the uniformity of the light with which the hologram recording medium 1 is irradiated.

### (Acquisition of Holographic 2D Information by Using Imaging Apparatus)

The hologram recording medium 1 records multiple pieces of 2D information are recorded, which are selectively reproduced simply by illuminating the hologram recording medium 1 with light at a variety of illumination angles. Recording individual ID information as the 2D information in the hologram recording medium 1 allows the hologram recording medium 1 or an object to which the hologram recording medium 1 is attached to be identified to be authentic or not by preparing the hologram reproduction apparatus 2 and switching a light source among a plurality of light sources to illuminate the hologram recording medium 1. It is preferable to carry out the authenticity identification not only by visual inspection but also machine-reading.

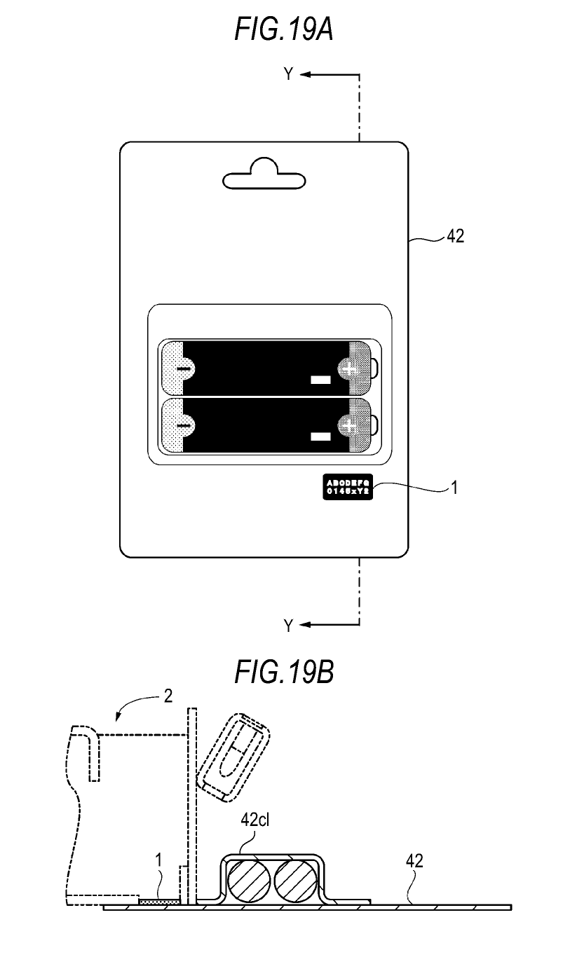

FIGS. 19A and 19B are schematic views showing an example in which a hologram recording medium having multiple pieces of 2D information recorded therein is attached to a product package. FIG. 19B is a cross-sectional view taken along the line Y-Y shown in FIG. 19A.

In the example shown in FIGS. 19A and 19B, a hologram recording medium 1 having multiple pieces of 2D information recorded therein is attached to part of a Brewster package 42 containing batteries. As the 2D information, a one-dimensional barcode and character information, for example, are recorded. When the hologram recording medium 1 is a light transmissive hologram, information printed on the surface onto which the hologram recording medium 1 is attached can be recognized through the hologram recording medium 1. In this case, the 2D information recorded in the hologram recording medium 1 does not prevent the printed information from being recognized.

The hologram recording medium 1 is disposed in the opening 4a in the hologram reproduction apparatus 2, and the recorded 2D information is viewed through the optical opening OP, as shown in FIG. 19B. Since the hologram reproduction apparatus 2 allows a transparent cover 42cl of the Brewster package 42 to abut the hologram reproduction apparatus 2, the hologram recording medium 1 and the hologram reproduction apparatus 2 can be used with the product enclosed in the Brewster package.

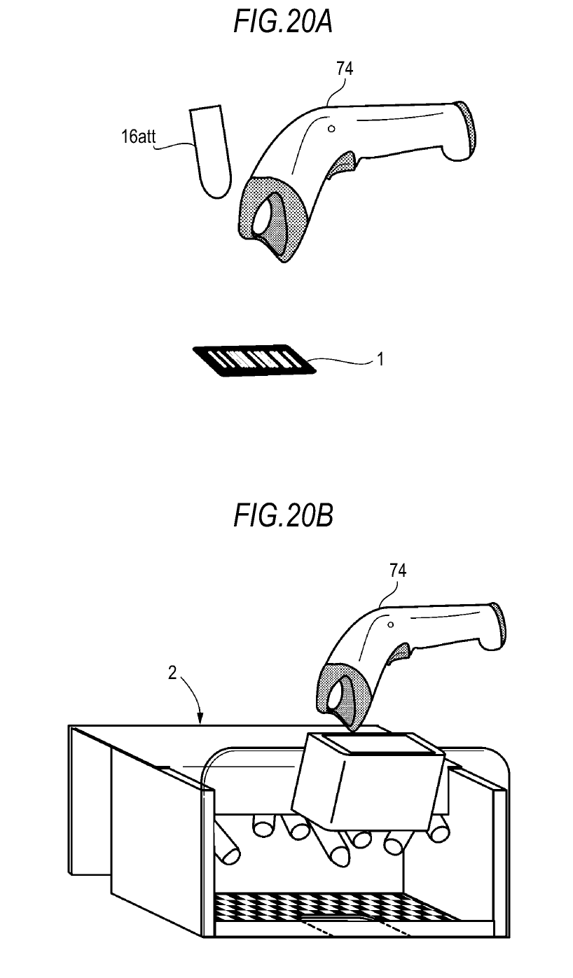

FIGS. 20A and 20B are schematic views showing an example of reading individual ID information formed of a barcode recorded in a hologram recording medium.

In the example shown in FIG. 20A, a diffusion light source attachment l6att combined, for example, with a diffuser and an LED is attached to a barcode reader 74, and the LED is turned on by operating the barcode reader 74. When a readout switch on the barcode reader 74 is operated to an ON position, the LED is turned on, and the LED is turned off when 2D information readout is completed. In this process, to reproduce the 2D information, it is necessary to illuminate and read the 2D information reliably in a predetermined direction.

In the example shown in FIG. 20B, the 2D information is read by using the attachment and other components to fix the barcode reader 74 to the hologram reproduction apparatus 2. The 2D information can be read in a reliable, quick manner by using configuration described above. Using the hologram reproduction apparatus 2 is also advantageous in that not only can the imaging distance and a target be clearly fixed but also unnecessary illumination is blocked. Using the hologram reproduction apparatus 2 therefore has an advantage of reducing occurrence of readout errors resulting from an external environment. Further, since multiple pieces of 2D information can be switched from one to another and read quickly, certification or authentication based on a combination of the multiple pieces of 2D information can be readily made. Further, the thus read information may be sent and received, for example, over wireless communication, optical communication, biocommunication to and from an information processing apparatus, a database, and other apparatus.

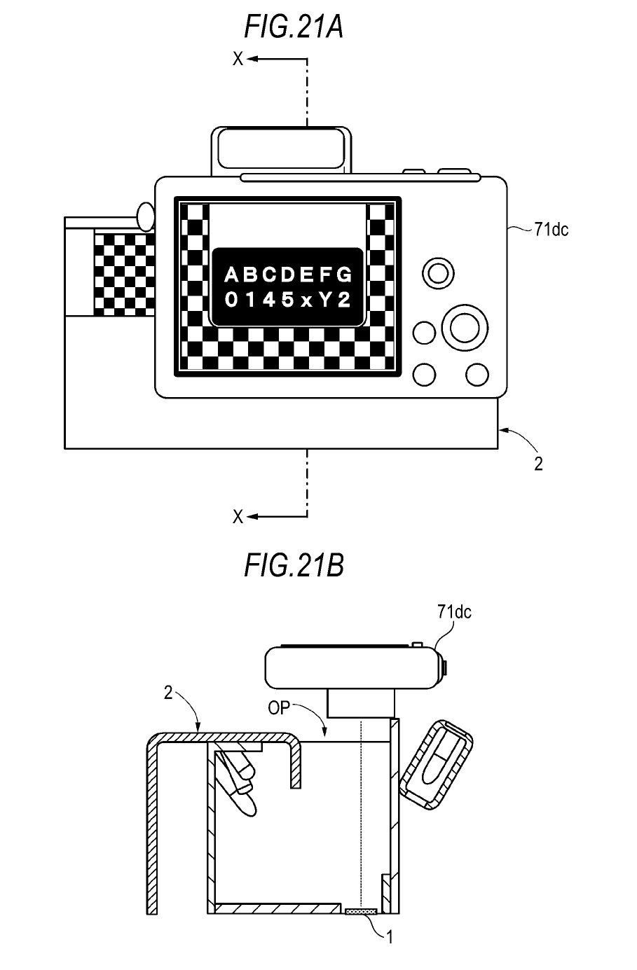

FIGS. 21A and 21B are schematic views showing an example in which a digital camera 71dc captures an image of a hologram recording medium 1 having multiple pieces of 2D information recorded therein. FIG. 21B is a cross-sectional view taken along the line X-X shown in FIG. 21A.

In the example shown in FIG. 21A, character information is reproduced as 2D information. In this case as well, an attachment or any other component is preferably used to fix the digital camera 71dc to the hologram reproduction apparatus 2. Alternatively, an imaging apparatus represented, for example, by a general-purpose digital camera, a USB (universal serial bus) camera, and a barcode reader may be incorporated in the hologram reproduction apparatus 2 itself. Still alternatively, an imaging device represented, for example, by a CCD (charge coupled device) and a CMOS (complementary metal-oxide semiconductor) device may be incorporated in the hologram reproduction apparatus 2 itself.

### (High-Frequency Pattern)

When holographically recorded 2D information is read by a digital camera, illuminating only a hologram may result in too high a contrast ratio and hence AF (auto focus) and AE (auto exposure) do not work in some cases.

The reason for this is that a typical digital camera employs an algorithm that judges a point where the contrast ratio is maximized is a focused point and the distance thereto to be a focused imaging distance. In other words, focus judgment in an AF process involves a bright and dark high-frequency component. To this end, the viewing stage 4 in the hologram reproduction apparatus 2 is provided with the high-frequency, brightness difference pattern 4p. In this case, 2D information to be reproduced is judged to be in focus when the high-frequency pattern 4p is judged to be in focus in the AF process. The high-frequency pattern 4p may be provided only around the opening 4a.

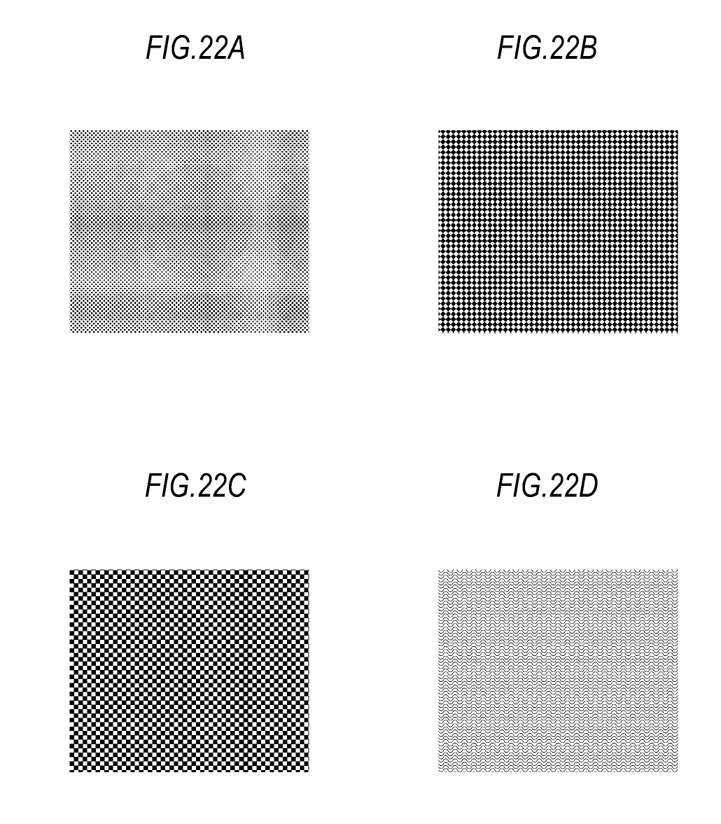

FIGS. 22A to 22D show examples of the high-frequency pattern. The patterns shown in FIGS. 22A to 22D are presented only by way of example, and any other suitable pattern, a combination of parts of those shown in FIGS. 22A to 22D, or an arbitrary pattern including black and white edges may be used. An arbitrary pattern to be used is not necessarily be a combination of black and white but may have any other suitable color combination. Increasing the proportion of high brightness portions is preferred because the amount of light incident on the imaging apparatus increases.

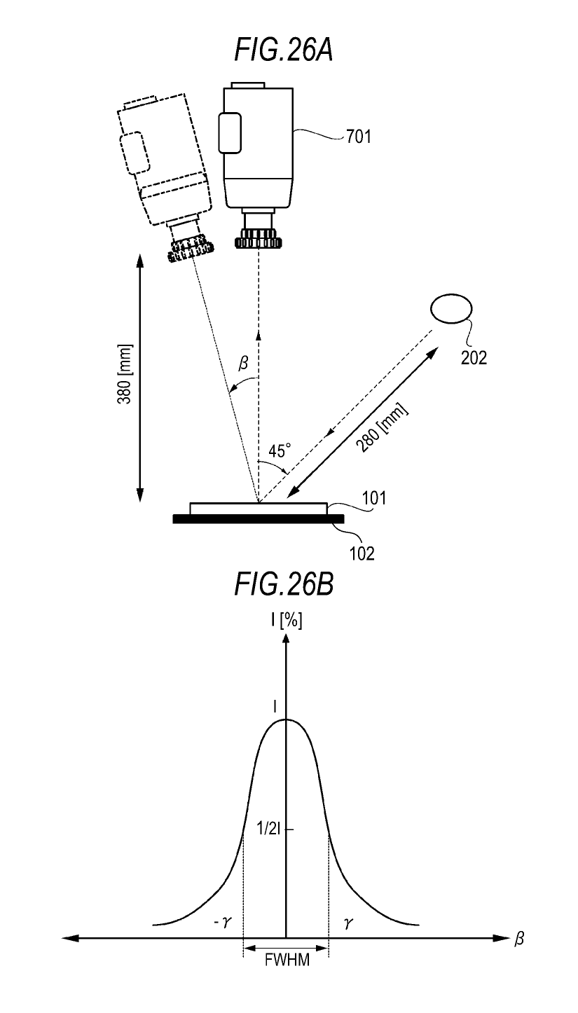

The difference in brightness between a high brightness portion and a low brightness portion basically results from the spectroscopic characteristic of the light source multiplied by the spectroscopic reflectance of the high-frequency pattern. In practice, the difference in brightness also depends on the spectroscopic characteristic of the sensor and a threshold in a contrast detection method and hence is hardly determined in a simple manner, but when a pattern having a difference of at least 20% in luminance ratio obtained in the luminance measurement defined in FIGS. 26A and 26B (measuring apparatus: luminance and color meter (Konica-Minolta CS-200), illumination light source: 45°-oblique illumination using halogen light source (Y: 96.0, x: 0.4508, y: 0.4075 on XY chromaticity diagram), and standard white plate: (Konica-Minolta CSA20)) is used, is has been shown that a high-frequency pattern is readily brought into focus in a statistically significant manner (according to results obtained in experiments using at least 20 types of commercially available digital cameras, barcode readers, and other apparatus).

The high brightness portions are preferably uniformly brightly shining surfaces. For example, the high-frequency pattern 4p may be formed of a luminous or fluorescent plate on which a black pattern is printed.

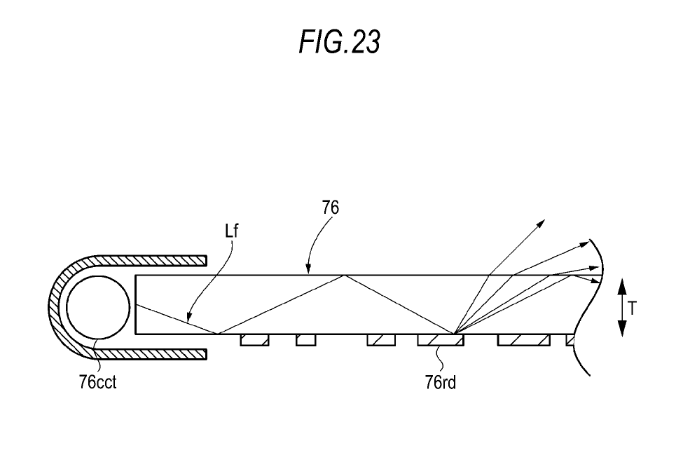

The high-frequency pattern 4p may alternatively be a backlight-based component. FIG. 23 is a diagrammatic cross-sectional view of an edge-lit backlight 76. As shown in FIG. 23, light Lf emitted from a cold cathode tube 76cct is repeatedly reflected in a light guide plate 76lgp, and the light reflected off reflection dots 76rd provided along one principle surface of the light guide plate 76lgp exits out of the light guide plate 76lgp to form high brightness portions. The backlight may alternatively be an overhead backlight provided with light blocking portions. When a backlight is used to form a high-frequency pattern, it is preferable to make the difference in height between the surface of the backlight and the surface of the hologram small so that both of them are readily brought into focus. Specifically, the thickness T of the light guide plate 76lgp is preferably 3 mm or smaller.

Alternatively, the hologram recording medium 1 and the high-frequency pattern 4p may be illuminated from a position that causes the diffracted light intensity of a reproduced image of any piece of 2D information recorded in the hologram recording medium 1 to be preferably 20% of a maximum value or lower, more preferably 10% or lower. The white LED light sources 12ₓ, 12_{y}, 12_{w}, and 12_{z} are disposed to provide such illumination. When a white light source is used, it has been shown that using a white light source having a color temperature ranging from 3000 to 9500K allows satisfactory white balance to be achieved in a digital camera or video camcorder having an auto white balance function.

A light source for illuminating a hologram preferably emits light containing a wavelength component corresponding to a color necessary to reproduce recorded information. It has been shown that a hologram to be reproduced in green, however, is readily brought into focus by using a white LED instead of using a green LED.

When a green Lippmann hologram is an object to be identified, preparing a red LED and providing a mode in which the hologram is viewed by turning only the red LED on is effective in authentication between the green Lippmann hologram and an embossed hologram produced to be similar thereto. The red LED light source 12_{E} for illuminating an embossed hologram is provided for such an authentication purpose. As the light source for illuminating an embossed hologram, a laser light source may be used as well as a red LED light source. In this case, the light for illuminating the hologram recording medium 1 desirably has peak intensity within a wavelength band that causes the diffracted light intensity of a reproduced image to be preferably 20% of a maximum value or lower, more preferably 10% or lower.

### Second Exemplary Configuration of Third Embodiment

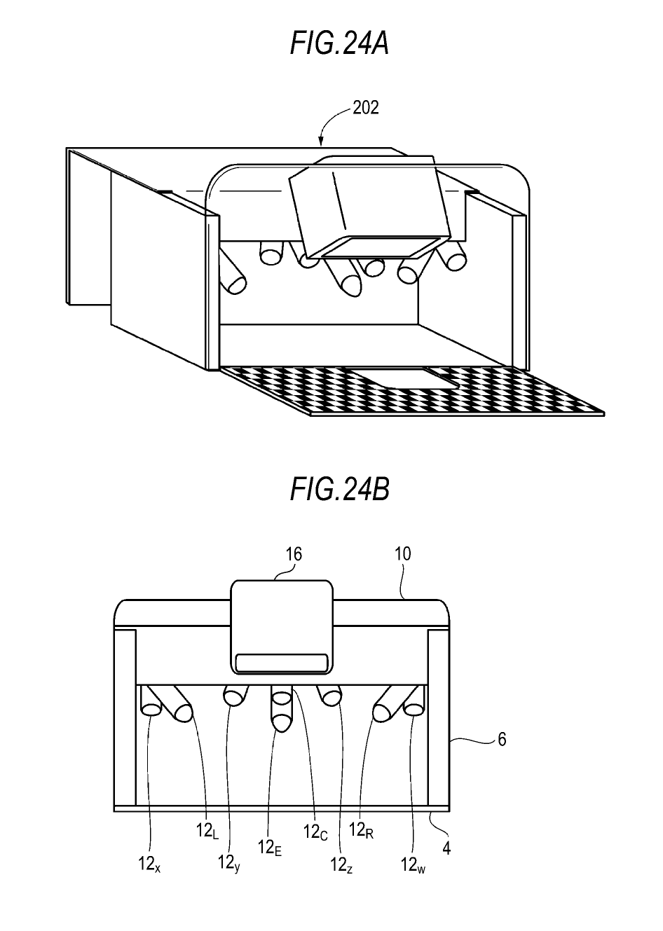

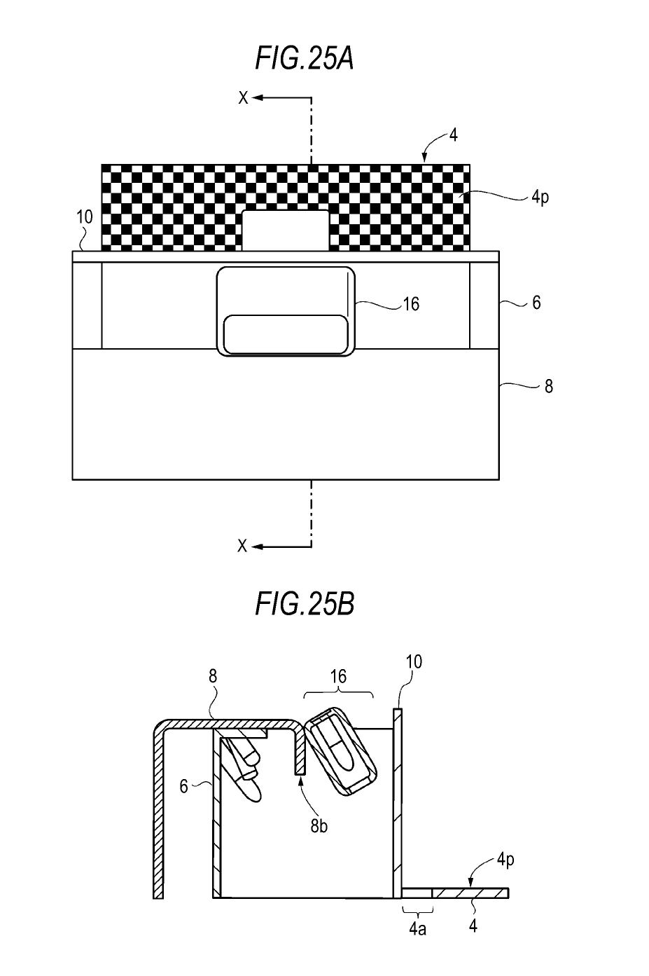

FIGS. 24A and 24B and FIGS. 25A and 25B show a second exemplary configuration of the apparatus for reproducing a hologram recording medium. FIG. 24A is a perspective view showing the second exemplary configuration of the hologram reproduction apparatus. FIG. 24B is a front view showing the second exemplary configuration of the hologram reproduction apparatus. FIG. 25A is a plan view showing the second exemplary configuration of the hologram reproduction apparatus. FIG. 25B is a cross-sectional view taken along the line X-X shown in FIG. 25A.

The second exemplary configuration differs from the first exemplary configuration in that the viewing stage 4 is not disposed in the housing of a hologram reproduction apparatus 202 but protrudes from the front side. As a result, no mirror 14 is provided and the portion above the opening 4a is open. In this example, the diffusion light source 16 is so disposed that the light emitted therefrom first passes through the transparent member 10 and then illuminates a hologram recording medium 1, as in the first exemplary configuration.

To reduce the size of the hologram reproduction apparatus 202, the viewing stage 4 maybe configured to retract into the housing, or a hinge or any other suitable component may be provided between the viewing stage 4 and the transparent member 10 so that the viewing stage 4 can be lifted above.

According to the second exemplary configuration of the third embodiment, individual pieces of information recorded in the hologram recording medium can be not only selectively reproduced but also readily, quickly, and reliably viewed, as in the first exemplary configuration of the third embodiment.

### 4. Variations

Preferred embodiments have been described above, but preferred specific examples are not limited to the above description. For example, 2D information may further include a serial number, a manufacturer, a lot number, a producer, a one-dimensional barcode, a two-dimensional barcode, and other identification information, and they can be recorded as individual ID information. Further, a fingerprint and other biometric information may be recorded. Recording individual ID information in the form of 2D information and machine-reading the recorded information can replace RFID (radio frequency identification) authentication or can be combined therewith. The hologram recording medium described above can also be used as information storage, such as a nonvolatile memory.

The number of pieces of recorded image information is not limited to two or three but may be greater. The direction in which information reproduced from a hologram recording medium is switched to another is not limited to the horizontal direction of the recording surface but may be the vertical direction, a diagonal direction, or any other direction.

The hologram recording medium described above can be attached to a product package, a noncontact IC card, an ID card, a back card, a credit card, an employee identification card, a student identification card, a season ticket, a driver license, a passport, a visa, securities, a bankbook, a revenue stamp, a postage stamp, a mobile phone, a coin, a lottery, and a variety of other items.

In the above description, a liquid crystal panel is used as a spatial light modulator, but the spatial light modulator is not limited thereto. Further, the diffuser 25 (or diffusers 25a and 25b) may be disposed in the vicinity of the hologram recording medium 1. Recording of image information has been described with reference to the case where the spatial light modulator is projected in a one-to-one projection scheme, but the spatial light modulator may be projected in a magnified or demagnified projection scheme. The film-shaped hologram recording medium described in the second embodiment maybe used as a hologram recording medium in the other embodiments.

The light source for illuminating the hologram recording medium 1 is not limited to an LED but may be a xenon lamp, a halogen lamp, a fluorescent lamp, or external light guided through an opening or an optical fiber.

The present disclosure contains subject matter related to that disclosed in Japanese Priority Patent Application JP 2010-149572 filed in the Japan Patent Office on Jun. 30, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A hologram recording medium having two or more images recorded therein,
wherein when substantially collimated light is incident along a first direction on the hologram recording medium, a first image is reproduced with the intensity of light diffracted in the hologram recording medium maximized in a predetermined direction,
when substantially collimated light is incident along a second direction on the hologram recording medium, a second image is reproduced with the intensity of light diffracted in the hologram recording medium maximized in the predetermined direction, and
a full width at half maximum of a reproduction angle of at least either of the diffracted light intensities of the first and second images is 8° or smaller.

2. The hologram recording medium according to claim 1,
wherein the directions in which the diffracted light intensities of the first and second images are maximized are close to the direction of a normal to a surface where the first and second images are recorded.

3. The hologram recording medium according to claim 2,
wherein the angle between the first direction and the normal is approximately 45°, and
the angle between the second direction and the normal is at least 10° but smaller than or equal to 35°.

4. The hologram recording medium according to claim 2,
wherein the angle between the first direction and the normal is approximately 45°, and
the angle between the second direction and the normal is at least 55° but smaller than or equal to 80°.

5. The hologram recording medium according to claim 2,
wherein the angle between the first direction and the normal is approximately 45°, and
the first and second directions are symmetric with respect to the normal.

6. The hologram recording medium according to claim 1,
wherein either of the diffracted light intensities of the first and second images in the vicinity of the direction of the normal is at least five times greater than the other diffracted light intensity.

7. The hologram recording medium according to claim 1,
wherein an image that diffracts light with a full width at half maximum of the reproduction angle of the diffracted light intensity being 8° or smaller is formed of a character, a number, a symbol, a figure, a pattern, a one-dimensional barcode, a two-dimensional barcode, or a combination thereof.

8. A method for manufacturing a hologram recording medium, the method comprising:
modulating laser beams in spatial light modulators into laser beams each of which contains additional information; and
irradiating a hologram recording medium through focusing optical systems with the modulated laser beams along with reference light,
wherein at least one of the focusing optical systems provides a diffusion angle having an absolute value of 7° or smaller.

9. A hologram reproduction apparatus comprising:
a viewing stage having an opening;
a support member fixed to at least part of the viewing stage;
a light blocking member having a light blocking portion and mounted on the support member on a side closer to a viewer than the viewing stage; and
a plurality of light sources mounted on the support member,
wherein the viewing stage is configured to position a hologram to be viewed when placed in the opening,
each of the plurality of light sources illuminates the hologram in a predetermined direction,
a portion of the light blocking member that corresponds to a portion above at least the opening is an optical opening, and
the light blocking portion prevents illumination light from each of the light sources from directly exiting through the optical opening.

10. The hologram reproduction apparatus according to claim 9,
wherein the plurality of light sources illuminate the hologram in different directions, and
the hologram reproduction apparatus further comprises a switcher capable of individually turning on and off the plurality of light sources.

11. The hologram reproduction apparatus according to claim 9,
wherein a high-frequency, brightness difference pattern is formed on at least part of the viewing stage.

12. The hologram reproduction apparatus according to claim 11,
wherein the high-frequency pattern is formed of an illuminator including a light guide plate, a light source disposed at an end of the light guide plate, and reflection members disposed in at least part of the light guide plate.

13. The hologram reproduction apparatus according to claim 11,
wherein the high-frequency pattern is partly made of a luminous or fluorescent material.

14. The hologram reproduction apparatus according to claim 9,
further comprising an imaging device.

15. The hologram reproduction apparatus according to claim 14,
further comprising a positioning member capable of positioning and fixing the imaging device.

16. The hologram reproduction apparatus according to claim 9,
further comprising a light diffusion function component disposed between at least one of the light sources and the hologram,
wherein the longitudinal length of the diffusion function component is at least 75% of V×cos α and V≦2L×tan β is satisfied (V denotes the longitudinal length of a recording area of the hologram, α denotes the angle between a normal dropped to the hologram and a line connecting the foot of the normal dropped to the hologram to the light source, L denotes the distance between the diffusion function component and the hologram, and ±β denotes a longitudinal diffusion angle provided by the diffusion function component).

17. The hologram reproduction apparatus according to claim 9,
further comprising a collimation lens disposed between at least one of the light sources and the hologram,
wherein the aperture diameter of the collimation lens is at least 75% of 2r×cos α (r denotes the radius of a circle that encloses a recording area of the hologram and α denotes the angle between a normal dropped to the hologram and a line connecting the foot of the normal dropped to the hologram to the light source).

18. The hologram reproduction apparatus according to claim 9,
further comprising a reflection plate having a radius of at least 75% of r×cos α (r denotes the radius of a circle that encloses a recording area of the hologram and α denotes the angle between a normal dropped to the hologram and a line connecting the foot of the normal to the light sources).

19. The hologram reproduction apparatus according to claim 9,
wherein a group of light sources formed of at least two of the light sources are disposed in an area defined by a circle having a radius r×cos α, where r denotes the radius of a circle that encloses a recording area of the hologram.

20. The hologram reproduction apparatus according to claim 17,
further comprising a light diffusion function component disposed between at least one of the light sources and the hologram.

21. The hologram reproduction apparatus according to claim 9,
further comprising a light source that illuminates the viewing stage in a direction that causes the intensity of light diffracted in an image recorded in the hologram to be smaller than or equal to one-tenth a maximum value of the diffracted light intensity.

22. The hologram reproduction apparatus according to claim 21,
wherein the light source that illuminates the viewing stage is a white light source having a color temperature ranging from 3000 to 9500K.

23. The hologram reproduction apparatus according to claim 9,
further comprising an LED or a laser light source having peak intensity within a wavelength band that causes the intensity of light diffracted in an image recorded in the hologram to be smaller than or equal to one-tenth a maximum value of the diffracted light intensity.

24. A hologram viewing method comprising:
(defining a direction of a normal dropped to a hologram having multiple pieces of image information recorded therein, a direction of illumination light that illuminates the hologram, and a direction in which the hologram is viewed);
selecting image information from the multiple pieces of image information recorded in the hologram by fixing any two of the directions and changing the remaining direction; and
viewing the selected image information.
